(19) United States
(12) Patent Application Publication
(10) Pub. No.: US 2022/0390232 A1
(43) Pub. Date: Dec. 8, 2022

(54) APPARATUS FOR USE WITH A ROTARY LASER LEVEL SYSTEM

(71) Applicant: Graham Procyk, Milton (CA)

(72) Inventor: Graham Procyk, Milton (CA)

(21) Appl. No.: 17/548,470

(22) Filed: Dec. 10, 2021

Related U.S. Application Data
(63) Continuation of application No. 63/124,768, filed on Dec. 12, 2020.
(60) Provisional application No. 63/148,386, filed on Feb. 11, 2021.

(51) Int. Cl. G01C 15/06; G01C 15/00

(52) U.S. Cl. CPC G01C 15/06; G01C 15/002

(57) ABSTRACT

An apparatus is for use with a rotary laser level system having a rotary laser level that shines a laser light that is received by remote re-positionable laser sensor, for mounting the re-positionable laser sensor in selectable elevation on a manually relocatable rod. The apparatus comprises a track presenting an outer face and rod-engaging face, and having a length extending between a top end and a bottom end, and a sensor carrier operatively mounted on the track for movement along the track. The sensor carrier comprises a housing, a wheel mounted on the housing in rotatable relation about a main axis, wherein the wheel is operatively engaged on the track such that rotation of the wheel causes movement of the wheel along the track, and means for selectively imparting rotation of the wheel about the main axis to thereby cause the sensor carrier to move along the track. In use, when the handle is rotated, the wheel correspondingly rotates, thereby moving the wheel along the track, and correspondingly moving the sensor carrier along the track to a selected position.

### FIELD OF THE INVENTION

The present invention relates to apparatuses used in conjunction with laser levelling equipment for use in establishing levels on construction sites, and more particularly to apparatuses used in conjunction with rotary laser level systems, specifically for supporting remote re-positionable laser sensors, for use in establishing levels on construction sites.

### BACKGROUND OF THE INVENTION

In the construction industry, it is necessary to accurately install horizontal and sloped surfaces, made from concrete, asphalt, and so on. Typically, rotary laser level systems are used to accurately determine the correct level of the surface at a plurality of locations by establishing the differences in vertical elevation from a point of known elevation to that of various pre-determined locations. Rotary laser level systems consist of a rotary laser that remains stationary, especially with respect to the point of known elevation, while a number of marker levels are determined. The laser light is received by one or more remote re-positionable laser sensors. Each re-positionable laser sensor is supported on a surveyor's rod that is held and moved around by a surveyor.

In use, the re-positionable laser sensor on the manually relocatable rod is moved vertically to a desired vertical position at the elevation of the laser beam. As the re-positional sensor is move vertically, it starts to beep as it nears the desired vertical position. When it reaches the desired vertical position, a steady tone is sounded.

Various types of prior art conventional devices for mounting the re-positionable laser sensor on a manually relocatable rod are known.

One such prior art device for mounting the re-positionable laser sensor on a manually relocatable rod can be found in U.S. Pat. No. 3,105,303, issued Oct. 1, 1963, to Frizzell, and entitled Levelling Instrument. The levelling instrument comprises, in combination, a height rod, a first sleeve adjustably mounted on the rod, a spring clip secured to the sleeve, a level removably retained by the clip, a second sleeve mounted on the rod and selectively connected to one end of the first sleeve, means for individually locking the sleeves to the rod, and an automatic tape reel removably secured to the second sleeve. A spring loaded catch is pivotally mounted between two protrusions disposed beneath the spring clip and is adapted to engage in a selected notch beneath the lower end of the first sleeve. The second sleeve is provided with a similar catch for positioning the sleeve in any desired position on the rod.

Another relevant prior art patent is U.S. Pat. No. 5,224,271, issued Jul. 6, 1993 to Langford Jr. (deceased), and entitled Leveling Test Apparatus and Method For Optical Instrument. The test apparatus and method are for noting whether the axis of sight of an optical instrument is parallel to the axis of a horizontal bubble level of that instrument. The apparatus has a vertically elongated first scale facing in one direction and a similarly calibrated second scale closely parallel to the first scale and facing in the opposite direction and selectively adjustable along the first scale. In the present method, first, the optical instrument is leveled midway between two such test apparatuses about 200 feet apart, with their respective second scales facing each other. Using the instrument, readings are taken on these second scales. Then the second scale of one test apparatus is adjusted along its first scale to a position thereon which matches the reading just taken on the second scale of the other test apparatus. Next the optical instrument is leveled at a position close to either test apparatus on the opposite side of it from the other test apparatus. Readings now are taken on the first scale of the closer test apparatus and on the second scale of the more distant test apparatus.

Another relevant prior art patent is U.S. Pat. No. 6,598,304 issued Jul. 29, 2003, to Akers, and entitled Laser Leveling System, Apparatus and Method for Building Construction. The laser leveling system is used to establish elevations in a building structure for installing cabinets, bookshelves, countertops, etc. There is a telescoping mounting post adapted to be positioned in bearing engagement between a floor surface and the top of a doorway, ceiling or other upper surface. A laser that transmits a horizontal laser beam is mounted to a mounting device that can be moved to different positions along the length of the post. Locking devices hold the laser-mounting device in place, and also properly position the post to be in firm engagement with its bearing surfaces. The laser-mounting device can be swung to upper and lower positions.

It has been found that conventional prior art systems have a number of problems associated with them. They are not convenient for readily vertically positioning the sensor to the desired elevation. At best, what is taught, is to slidably move the sensor upwardly or downwardly by hand, while attempting to retain the sensor in the correct vertical position, and simultaneously tightening a threaded fastener to lock the sensor in place. This type of apparatus is difficult to use and takes longer to get the sensor correctly vertically positioned than is desirable. Also, current currently available devices are overly complicated and not easy to use for the general worker without a background in surveying, which often leads to errors. Also, many units cannot be readily removed from a surveying rod, and therefore sometimes cannot readily be carried around or otherwise transported.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit is easy to use.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit takes less takes time to get the sensor correctly vertically positioned than prior art devices.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit is not overly complicated.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit is easy to use.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit helps to minimize errors.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit can readily be removed from a surveying rod.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit can readily be carried around.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit can readily be transported.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit is a convenient size for shipping.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit is inexpensive to produce and market.

It is an object of the present invention to provide an apparatus and/or kit for use with a rotary laser level system having a rotary laser level that shines a laser light that is received by remote re-positionable laser sensor, for mounting the re-positionable laser sensor in selectable elevation on a manually relocatable rod, wherein the apparatus and/or kit presents the require information on a digital display.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit is easy to use.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit takes less takes time to get the sensor correctly vertically positioned than prior art devices.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit is not overly complicated.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit is easy to use.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit helps to minimize errors.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit can readily be removed from a surveying rod.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit can readily be carried around.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit can readily be transported.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit is a convenient size for shipping.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit is inexpensive to produce and market.

It is an object of the present invention to provide an apparatus and/or kit for use with a rotary laser level system having a rotary laser level that shines a laser light that is received by remote re-positionable laser sensor, for permitting selective re-positioning of the re-positionable laser sensor in selectable elevation on a main body member, wherein the apparatus and/or kit presents the require information on a digital display.

### SUMMARY OF THE INVENTION

In accordance with one aspect of the present invention there is disclosed a novel apparatus for use with a rotary laser level system having a rotary laser level that shines a laser light that is received by remote re-positionable laser sensor, for mounting the re-positionable laser sensor in selectable elevation on a manually relocatable rod. The apparatus comprises a track; a sensor carrier operatively mounted on the track for movement along the track, wherein the sensor carrier comprises (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel kit comprising a track; a sensor carrier operatively mounted on the track for movement along the track, wherein the sensor carrier comprises (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel apparatus for use with a rotary laser level system having a rotary laser level that shines a laser light that is received by a remote re-positionable laser sensor, for permitting selective re-positioning of the re-positionable laser sensor in selectable elevation. The apparatus comprises a main body member; a track; a sensor carrier operatively mounted on the track for movement along the track, wherein the sensor carrier comprises (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel kit comprising a main body member; a track; a sensor carrier operatively mounted on the track for movement along the track. The sensor carrier comprises (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel apparatus for use with a rotary laser level system having a rotary laser level that shines a laser light that is received by a remote re-positionable laser sensor, for mounting the re-positionable laser sensor in selectable elevation on a manually relocatable rod. The apparatus comprises a track; a sensor carrier operatively engageable with the track for travel along the track; wherein the remote re-positionable laser sensor is mounted on the sensor carrier for travel with the sensor carrier along the track; a measurement strip; and a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; wherein the strip sensor is connected in signal transfer relation to an electronic digital readout; and wherein, in use, when the sensor carrier is moved along the track, the strip sensor travels along the measurement strip and produces corresponding displacement signals and transmits the corresponding displacement signals to the electronic digital readout for use in displaying the elevation.

In accordance with one aspect of the present invention there is disclosed a novel kit comprising a track; a sensor carrier operatively engageable with the track for travel along the track; wherein the remote re-positionable laser sensor is mounted on the sensor carrier for travel with the sensor carrier along the track; a measurement strip; and a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; wherein the strip sensor is connected in signal transfer relation to an electronic digital readout; and wherein, in use, when the sensor carrier is moved along the track, the strip sensor travels along the measurement strip and produces corresponding displacement signals and transmits the corresponding displacement signals to the electronic digital readout for use in displaying the elevation.

In accordance with one aspect of the present invention there is disclosed a novel apparatus for use with a rotary laser level system having a rotary laser level that shines a laser light that is received by a remote re-positionable laser sensor, for permitting selective re-positioning of the re-positionable laser sensor in selectable elevation. The apparatus comprises a main body member; a track; a sensor carrier operatively engageable with the track for travel along the track; wherein the remote re-positionable laser sensor is mounted on the sensor carrier for travel with the sensor carrier along the track; a measurement strip; and a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; wherein the strip sensor is connected in signal transfer relation to an electronic digital readout; and wherein, in use, when the sensor carrier is moved along the track, the strip sensor travels along the measurement strip and produces corresponding displacement signals and transmits the corresponding displacement signals to the electronic digital readout for use in displaying the elevation.

In accordance with one aspect of the present invention there is disclosed a novel kit comprising a main body member; a track; a sensor carrier operatively engageable with the track for travel along the track; wherein the remote re-positionable laser sensor is mounted on the sensor carrier for travel with the sensor carrier along the track; a measurement strip; and a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; wherein the strip sensor is connected in signal transfer relation to an electronic digital readout; and wherein, in use, when the sensor carrier is moved along the track, the strip sensor travels along the measurement strip and produces corresponding displacement signals and transmits the corresponding displacement signals to the electronic digital readout for use in displaying the elevation.

In accordance with one aspect of the present invention there is disclosed a novel assembly for use with a rotary laser level system having a rotary laser level that shines a laser light that is received by remote re-positionable laser sensor, for mounting the re-positionable laser sensor in selectable elevation on a manually relocatable rod, the assembly comprising a track; a sensor carrier operatively mounted on the track for movement along the track, wherein the sensor carrier comprises (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; and wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel combination of a track; a sensor carrier operatively mounted on the track for movement along the track, wherein the sensor carrier comprises (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel method of positioning a remote re-positionable laser sensor for receiving laser light from a rotary laser level, the method comprising the steps of positioning a track in a generally upright orientation; rotating a wheel operatively engaged with the track to cause movement of the wheel along the track, and thereby move the sensor along the track to a selected position to thereby receive the laser light.

In accordance with one aspect of the present invention there is disclosed a novel track for use in conjunction with a rotary laser level system, the track comprising a main body extending between a top end and a bottom end, and having a gear rack, and presenting an outer face and a rod-engaging face.

In accordance with one aspect of the present invention there is disclosed a novel system comprising a track; a wheel mounted on a housing in rotatable relation about a main axis, wherein the wheel is operatively engaged on the track such that rotation of the wheel causes movement of the wheel along the track; means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel adjustment system for facilitating the movement of a sensor carrier along the track to a selected position, the adjustment system comprising a wheel mounted on a housing in rotatable relation about a main axis, wherein the wheel is operatively engaged on the track such that rotation of the wheel causes movement of the wheel along the track; means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel assembly for use with a rotary laser level system having a rotary laser level that shines a laser light that is received by remote re-positionable laser sensor, for mounting the re-positionable laser sensor in selectable elevation on a manually relocatable rod, the assembly comprising a main body member; a track; a sensor carrier operatively mounted on the track for movement along the track, wherein the sensor carrier comprises: (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel combination of a main body member; a track; a sensor carrier operatively mounted on the track for movement along the track, wherein the sensor carrier comprises (1) a housing; (2) a wheel mounted on the housing in rotatable relation about a main axis, wherein the wheel is operatively engaged on the track such that rotation of the wheel causes movement of the wheel along the track; (3) means for selectively imparting rotation of the wheel about the main axis to thereby cause the sensor carrier to move along the track; wherein, in use, when the handle is rotated, the wheel correspondingly rotates, thereby moving the wheel along the track, and correspondingly moving the sensor carrier along the track to a selected position.

In accordance with one aspect of the present invention there is disclosed a novel assembly for use with a rotary laser level system having a rotary laser level that shines a laser light that is received by a remote re-positionable laser sensor, for mounting the re-positionable laser sensor in selectable elevation on a manually relocatable rod, the assembly comprising a track; a sensor carrier operatively engageable with the track for travel along the track; wherein the remote re-positionable laser sensor is mounted on the sensor carrier for travel with the sensor carrier along the track; a measurement strip; and, a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; and wherein the strip sensor is connected in signal transfer relation to an electronic digital readout; and, wherein, in use, when the sensor carrier is moved along the track, the strip sensor travels along the measurement strip and produces corresponding displacement signals and transmits the corresponding displacement signals to the electronic digital readout for use in displaying the elevation.

In accordance with one aspect of the present invention there is disclosed a novel combination of a track; a sensor carrier operatively engageable with the track for travel along the track; wherein the remote re-positionable laser sensor is mounted on the sensor carrier for travel with the sensor carrier along the track; a measurement strip; and, a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; wherein the strip sensor is connected in signal transfer relation to an electronic digital readout; and, wherein, in use, when the sensor carrier is moved along the track, the strip sensor travels along the measurement strip and produces corresponding displacement signals and transmits the corresponding displacement signals to the electronic digital readout for use in displaying the elevation.

In accordance with one aspect of the present invention there is disclosed a novel assembly for use with a rotary laser level system having a rotary laser level that shines a laser light that is received by a remote re-positionable laser sensor, for permitting selective re-positioning of the re-positionable laser sensor in selectable elevation, the apparatus comprising a main body member; a track; a sensor carrier operatively engageable with the track for travel along the track; wherein the remote re-positionable laser sensor is mounted on the sensor carrier for travel with the sensor carrier along the track; a measurement strip; and, a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; wherein the strip sensor is connected in signal transfer relation to an electronic digital readout; and, wherein, in use, when the sensor carrier is moved along the track, the strip sensor travels along the measurement strip and produces corresponding displacement signals and transmits the corresponding displacement signals to the electronic digital readout for use in displaying the elevation.

In accordance with one aspect of the present invention there is disclosed a novel combination of a main body member; a track; a sensor carrier operatively engageable with the track for travel along the track; wherein the remote re-positionable laser sensor is mounted on the sensor carrier for travel with the sensor carrier along the track; a measurement strip; and, a strip sensor mounted on the sensor carrier for travel with the sensor carrier along the track and in adjacent relation to the measurement strip for movement along the measurement strip, for detecting changes in portions of the measurement strip as the strip sensor travels along the measurement strip; wherein the strip sensor is connected in signal transfer relation to an electronic digital readout; and, wherein, in use, when the sensor carrier is moved along the track, the strip sensor travels along the measurement strip and produces corresponding displacement signals and transmits the corresponding displacement signals to the electronic digital readout for use in displaying the elevation.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a first illustrated embodiment of the invention will now be illustrated by way of example.

It is expressly understood, however, that the drawings are for the purpose of illustration and description only, and are not intended as a definition of the limits of the invention. In the accompanying drawings:

FIG. 1 is a isometric view from the bottom of the first illustrated embodiment of the apparatus according to the present invention showing the track and the sensor carrier separated each from the other;

FIG. 2 is a isometric view from the bottom of the first illustrated embodiment of the apparatus of FIG. 1, with the track securely mounted on a manually relocatable rod;

FIG. 3 is a isometric view from the bottom of the first illustrated embodiment of the apparatus of FIG. 1, with the sensor carrier supported by the track and the manually relocatable rod;

FIG. 4 is an isometric view from the bottom of the first illustrated embodiment of the apparatus of FIG. 1, with the sensor carrier supported by the track and the manually relocatable rod;

FIG. 5 is a bottom view of the first illustrated embodiment of the sensor carrier of the apparatus of FIG. 1;

FIG. 6 is a cross-sectional view of the first illustrated embodiment of the sensor carrier of FIG. 5, taken along section line 6-6 of FIG. 5;

FIG. 7 is a cross-sectional view of the first illustrated embodiment of the sensor carrier of FIG. 5, taken along section line 7-7 of FIG. 5;

FIG. 8 is a cross-sectional view of the first illustrated embodiment of the sensor carrier of FIG. 5, taken along section line 8-8 of FIG. 7;

FIG. 9 is a bottom view of the first illustrated embodiment of the outer frame of the sensor carrier of FIG. 5;

FIG. 10 is a left side view of the first illustrated embodiment of the outer frame of FIG. 9;

FIG. 11 is a front view of the first illustrated embodiment of the outer frame of FIG. 9;

FIG. 12 is a bottom view of the first illustrated embodiment of the inner frame of the sensor carrier of FIG. 5;

FIG. 13 is a right side view of the first illustrated embodiment of the inner frame of FIG. 12;

FIG. 14 is a front view of the first illustrated embodiment of the inner frame of FIG. 12;

FIG. 15 is a bottom view of the first illustrated embodiment of the bottom plate of the sensor carrier of FIG. 5;

FIG. 16 is a top view of the first illustrated embodiment of the bottom plate of FIG. 15;

FIG. 17 is a left side view of the first illustrated embodiment of the bottom plate of FIG. 15;

FIG. 18 is a front view of the first illustrated embodiment of the inner frame of FIG. 15;

FIG. 19 is a top view of the first illustrated embodiment of the top plate of the sensor carrier of FIG. 5;

FIG. 20 is a right side view of the first illustrated embodiment of the top plate of FIG. 19;

FIG. 21 is a bottom view of the first illustrated embodiment of the track-engaging bridge of the sensor carrier of FIG. 5;

FIG. 22 is a right side view of the first illustrated embodiment of the track-engaging bridge of FIG. 21;

FIG. 23 is a front view of the first illustrated embodiment of the track-engaging bridge of FIG. 21;

FIG. 24 is a bottom view of the first illustrated embodiment of the apparatus of FIG. 1, in use;

FIG. 25 is a right side view of the first illustrated embodiment of the apparatus of FIG. 1, in use;

FIG. 26 is an enlarged right side view of a portion of FIG. 25;

FIG. 27 is a front view of the first illustrated embodiment of the track of the apparatus of FIG. 1;

FIG. 28 is a right side view of the first illustrated embodiment of the track of FIG. 27;

FIG. 29 is an enlarged right side view of a portion of the first illustrated embodiment of the track of FIG. 28;

FIG. 30 is an enlarged top view of a portion of the first illustrated embodiment of the track of FIG. 27;

FIG. 31 is a right side view of the first illustrated embodiment of the pinion gear of the apparatus of FIG. 1;

FIG. 32 is an edge view of the first illustrated embodiment of the pinion gear of FIG. 31;

FIG. 33 is an edge view of the first illustrated embodiment of the bottom wall of the apparatus of FIG. 1;

FIG. 34 is a front view of the first illustrated embodiment of the apparatus of FIG. 1, ready for use;

FIG. 35 is a rear view of the first illustrated embodiment of the apparatus of FIG. 1, ready for use;

FIG. 36 is a left side view of the first illustrated embodiment of the apparatus of FIG. 1, ready for use;

FIG. 37 is a right side view of the first illustrated embodiment of the apparatus of FIG. 1, ready for use;

FIG. 38 is a top side view of the first illustrated embodiment of the apparatus of FIG. 1, ready for use;

FIG. 39 is a isometric view from below of the first illustrated embodiment of the apparatus of FIG. 1, ready for use;

FIG. 40 is a top view from the right side of the first illustrated embodiment of the apparatus of FIG. 1, ready for use;

FIG. 41 is a top view from the left side of the first illustrated embodiment of the apparatus of FIG. 1, ready for use.

FIG. 41 is a top view from the left side of the first illustrated embodiment of the apparatus of FIG. 1, ready for use.

FIG. 42 is an isometric view from the bottom of the second illustrated embodiment of the according to the present invention, with the sensor carrier supported by the track and the manually relocatable rod;

FIG. 43 is a front view from the side of the third illustrated embodiment of the according to the present invention, with the sensor carrier supported by the track and the manually relocatable rod, and the measurement strip secured to the track;

FIG. 44 is an enlarged perspective view of the third illustrated embodiment of the apparatus of FIG. 43;

FIG. 45 is an enlarged perspective view of the third illustrated embodiment of the apparatus of FIG. 43;

FIG. 46 is an enlarged perspective view of the third illustrated embodiment of the apparatus of FIG. 43;

FIG. 47 is an enlarged side view looking down of the third illustrated embodiment of the apparatus of FIG. 43;

FIG. 48 is an enlarged side view of the third illustrated embodiment of the apparatus of FIG. 43;

FIG. 49 is an enlarged perspective view looking down of the third illustrated embodiment of the apparatus of FIG. 43;

FIG. 50 is an enlarged perspective view from the front looking up of the third illustrated embodiment of the apparatus of FIG. 43;

FIG. 51 is an enlarged perspective view from the front of the third illustrated embodiment of the apparatus of FIG. 43;

FIG. 52 is an enlarged perspective view from the front of the third illustrated embodiment of the apparatus of FIG. 43;

FIG. 53 is a greatly enlarged perspective view from the front of a portion of the third illustrated embodiment of the apparatus of FIG. 43; and,

FIG. 54 is a greatly enlarged perspective view from the front of a portion of the third illustrated embodiment of the apparatus of FIG. 43, specifically of the top mounting bracket.

### LIST OF COMPONENTS AND REFERENCE NUMERALS

100 Apparatus
102 Rotary laser level system
104 Rotary laser level
106 Remote re-positionable laser sensor
108 Manually relocatable rod
120 Track
120t Top end
120b Bottom end
121a Left side edge
121b Right side edge
122 Gear rack
123 Gear teeth
124 Outer face
125a Left shoulder area
125b Right shoulder area
126 Rod-engaging face
126a First scale
126b Second scale
140 Sensor carrier
149 Small plate
150 Housing
150a Top
150b Bottom
150c Front portion/Front wall
150d Back portion/Back wall
150e Left side portion/Left side wall
150f Right side portion/Right side wall
150i Inner housing
150o Outer housing
151 Base
152 Arms
153 Biasing springs
154 Posts
154a Apertures
154b Apertures
155 Washers
156 Drive shaft
156p Pin
157 Apertures
157b Bushings
158 Elongate openings
159 Throughpassage
160 Wheel/pinion gear
160b Boreholes
160h Hub
170 Means for selectively imparting rotation/main handle
180 Threaded securing fastener
181 Small handle
182 Top cover
184 Bottom cover
185 Threaded borehole
186 Extension portion
187 Track-engaging bridge
188a Left leg
188b Right leg
189 Base portion
“L” Length
“M” Axis
200 Apparatus
202 Rotary laser level system
204 Rotary laser level
206 Re-positionable laser sensor
208 Main body member
220 Track
300 Apparatus
302 Rotary laser level system
304 Rotary laser level
306 Re-positionable laser sensor
308 Manually relocatable rod
310 Measurement strip
311 Top end
311m Top mounting bracket
312 Bottom end
312m Bottom mounting bracket
314a, 314b Alternatingly oriented magnetic sections
320 Track
320t Top end
320b Bottom end
322 Gear rack
323 Gear teeth
350 Housing
360 Wheel/pinion gear
370 Means for selectively imparting rotation/main handle
380 Threaded securing fastener
390 Strip sensor
395 Electronic digital readout
398 Strip sensor housing
“L” Length
“M” Main axis

### DETAILED DESCRIPTION OF THE ILLUSTRATED EMBODIMENTS

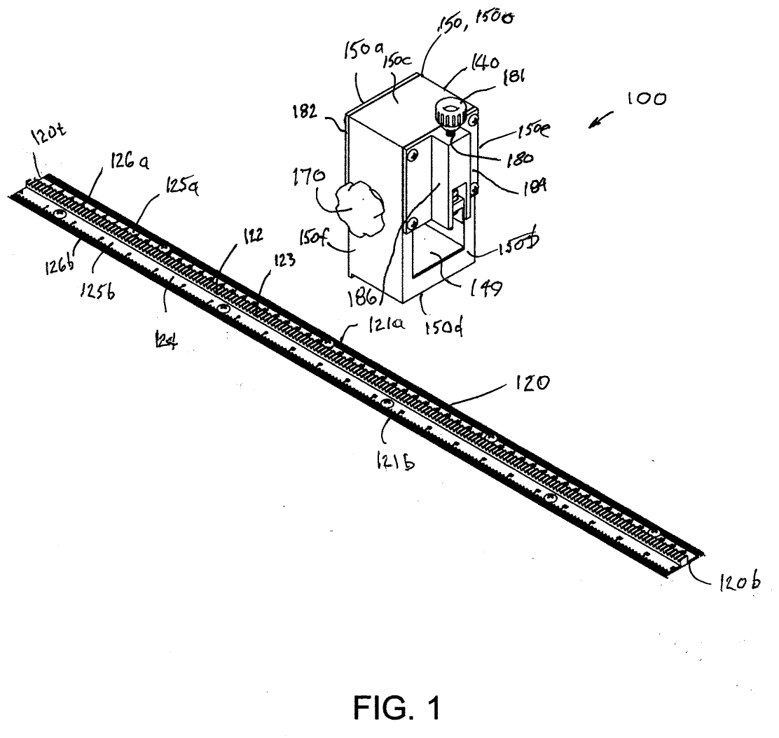

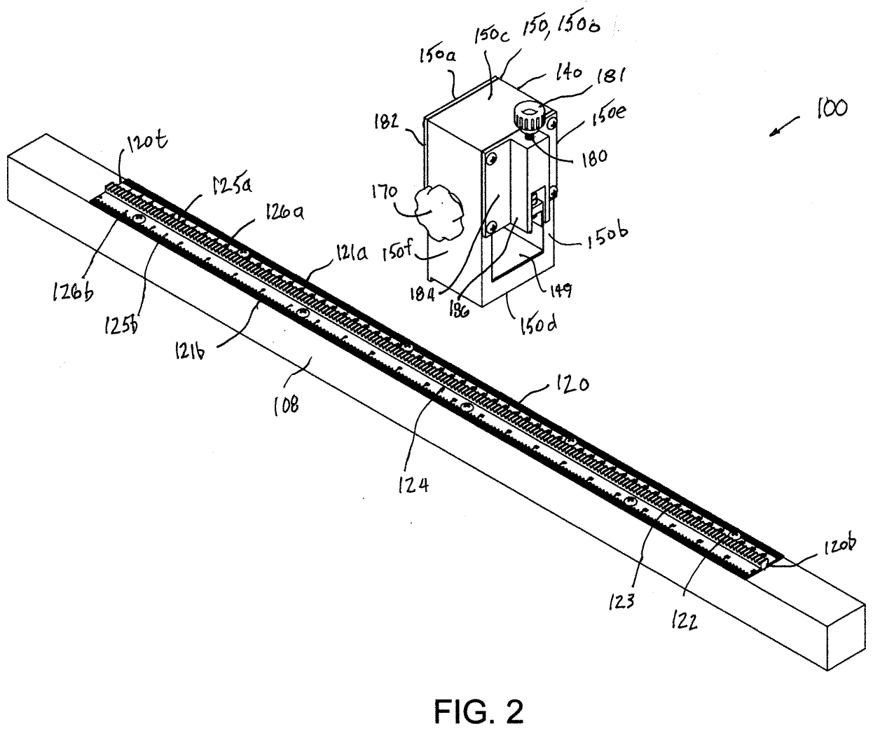

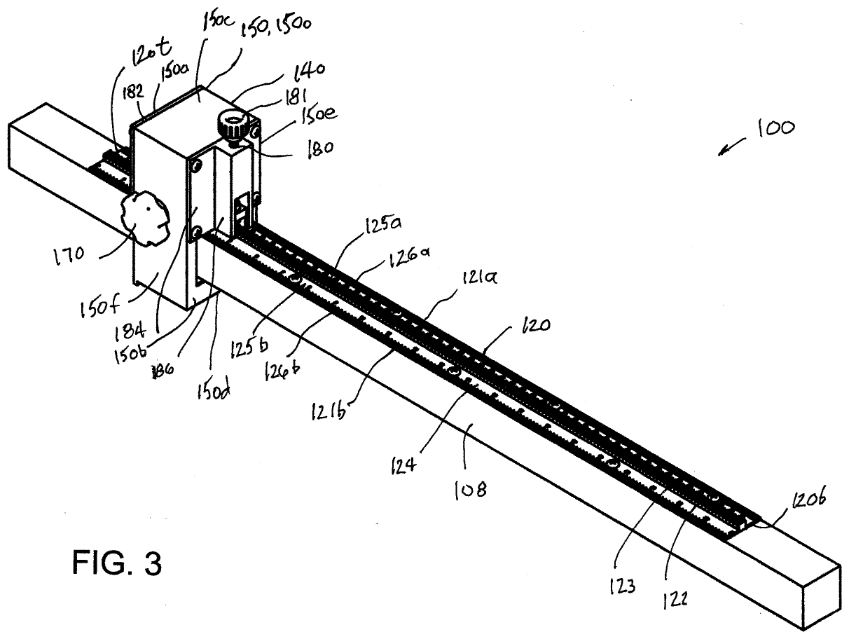

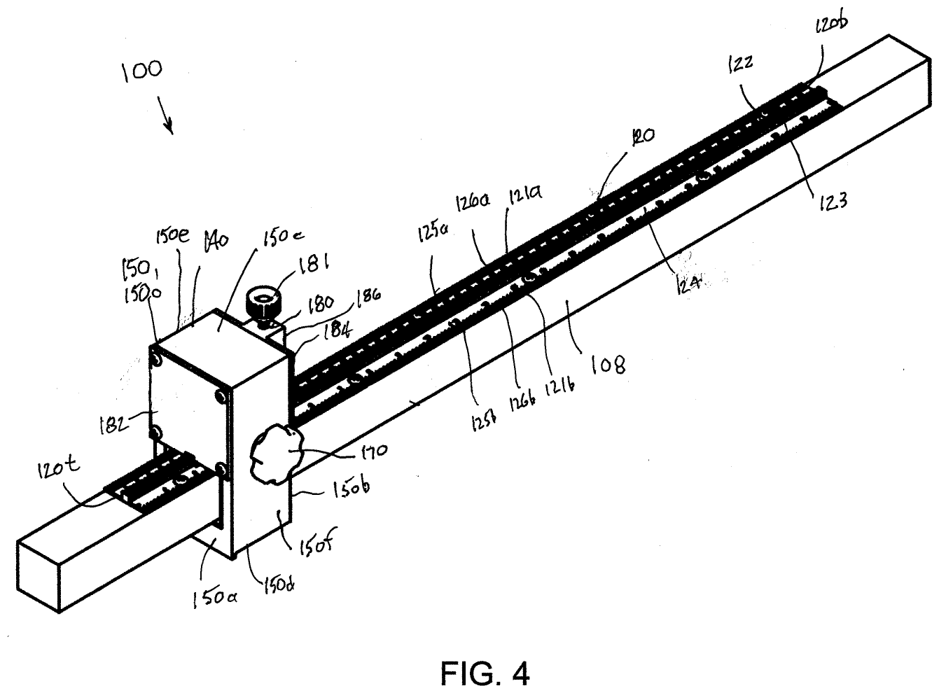

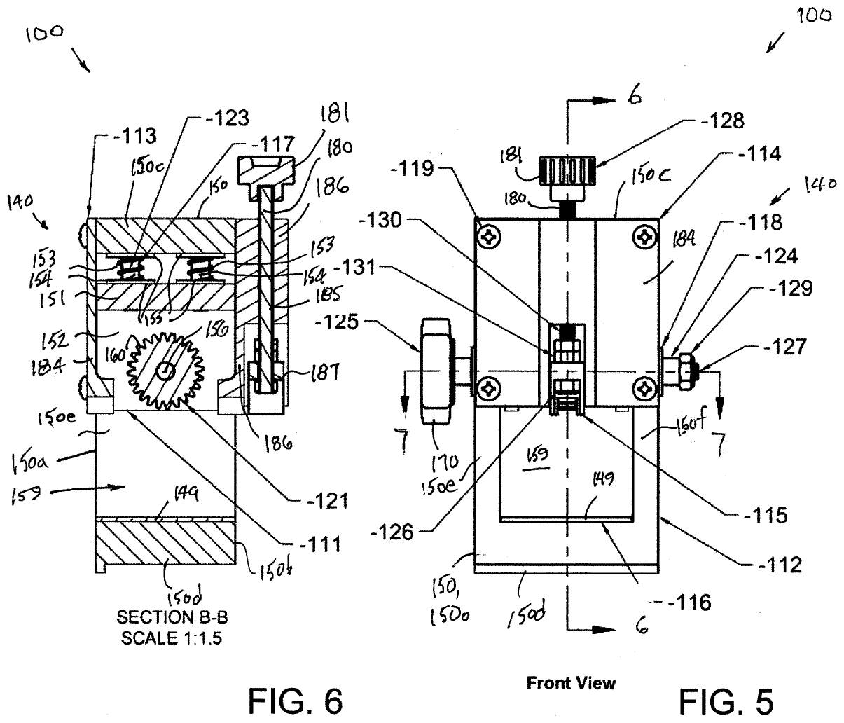

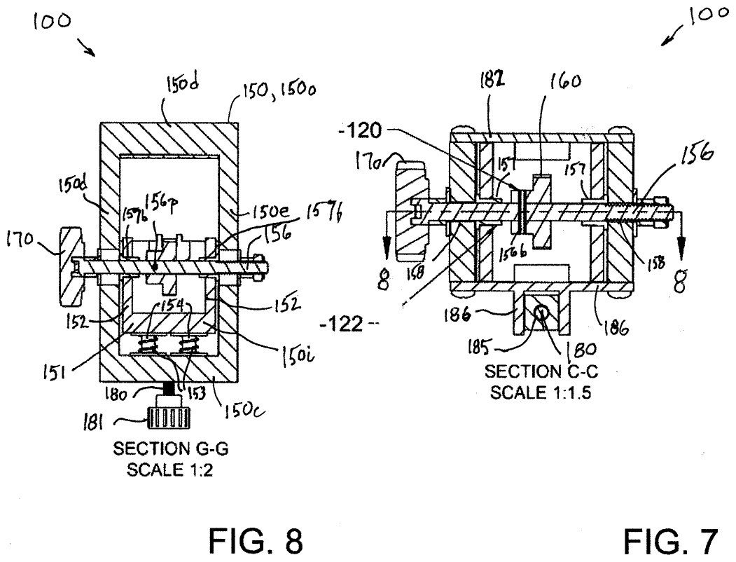

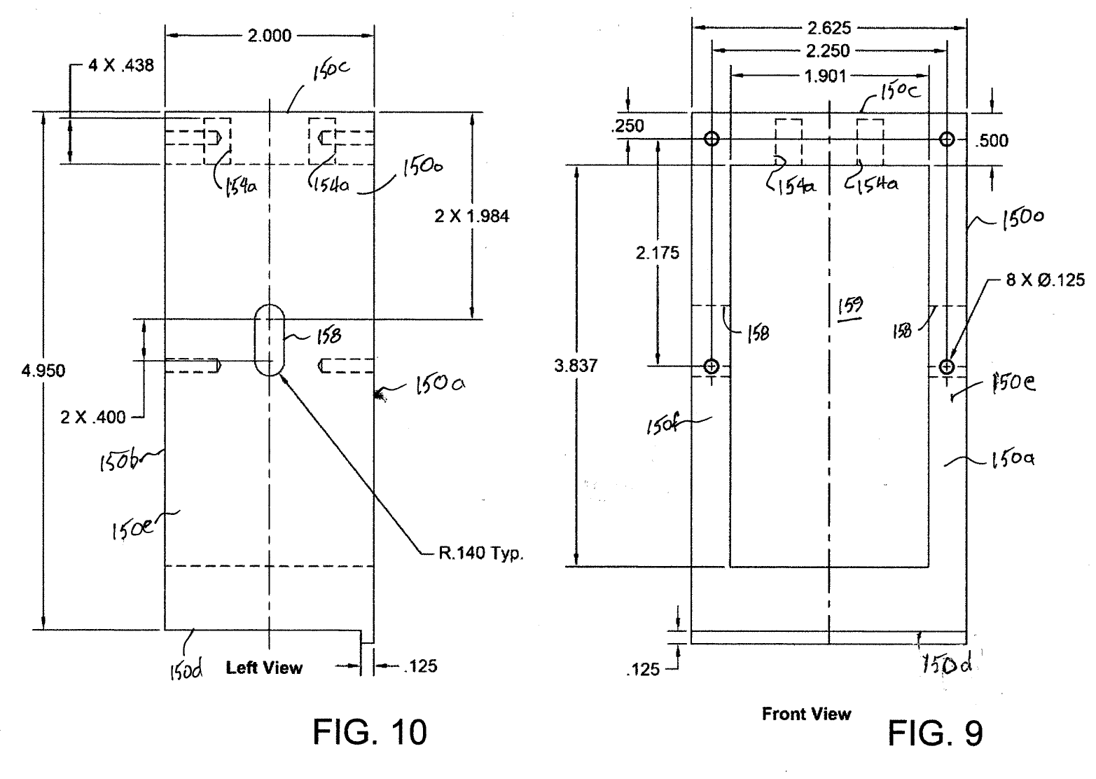

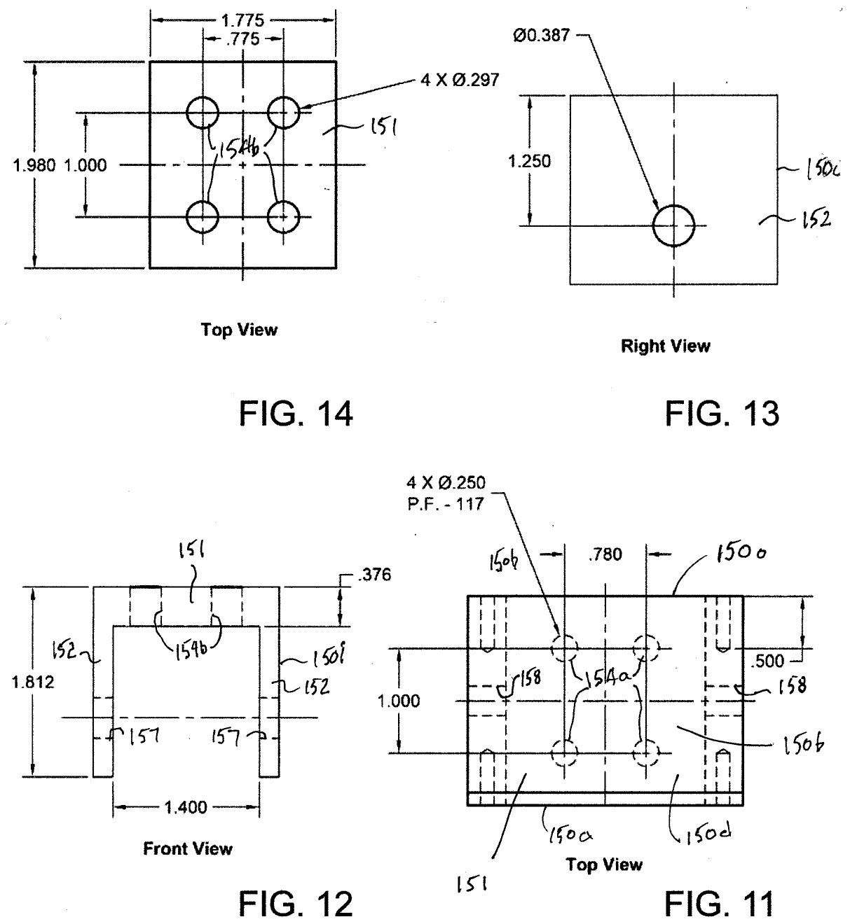

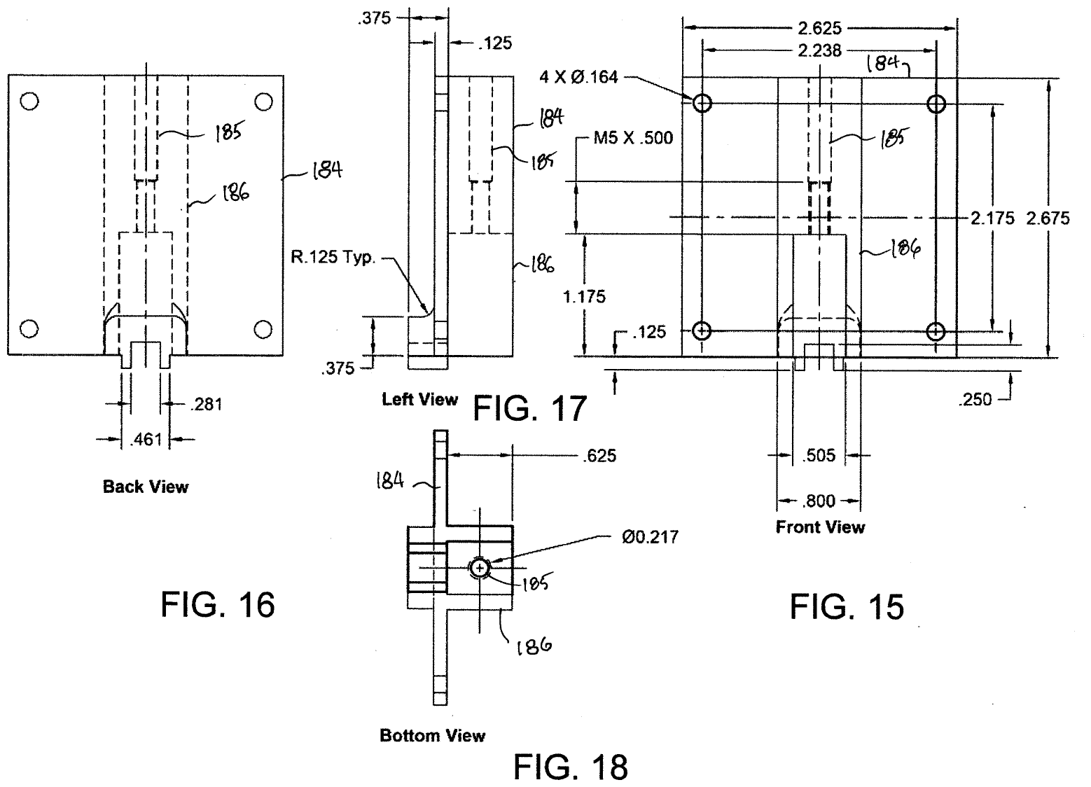

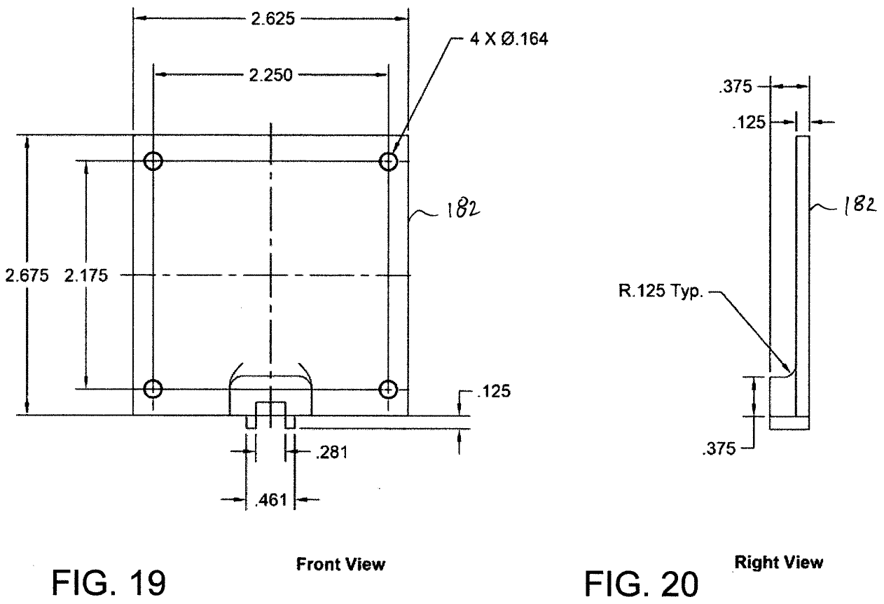

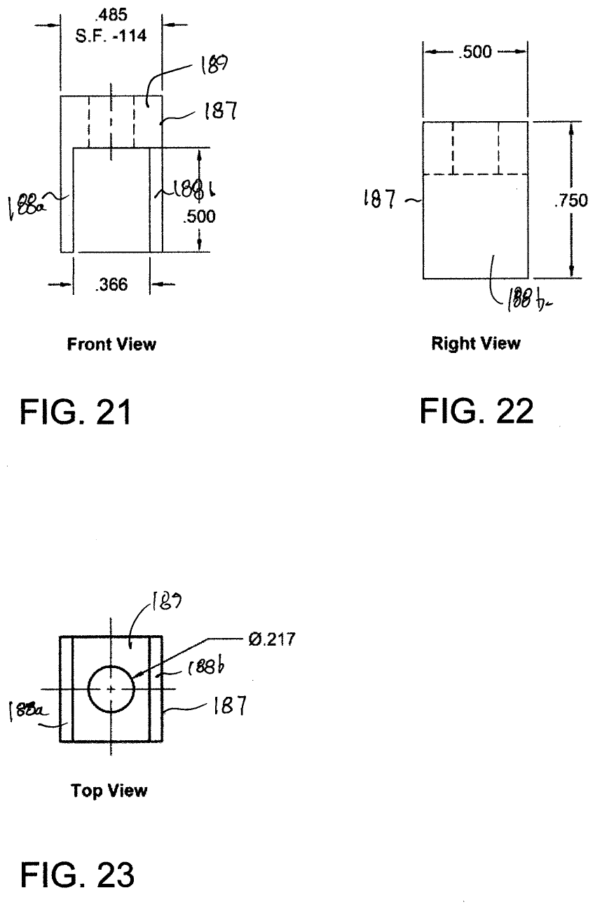

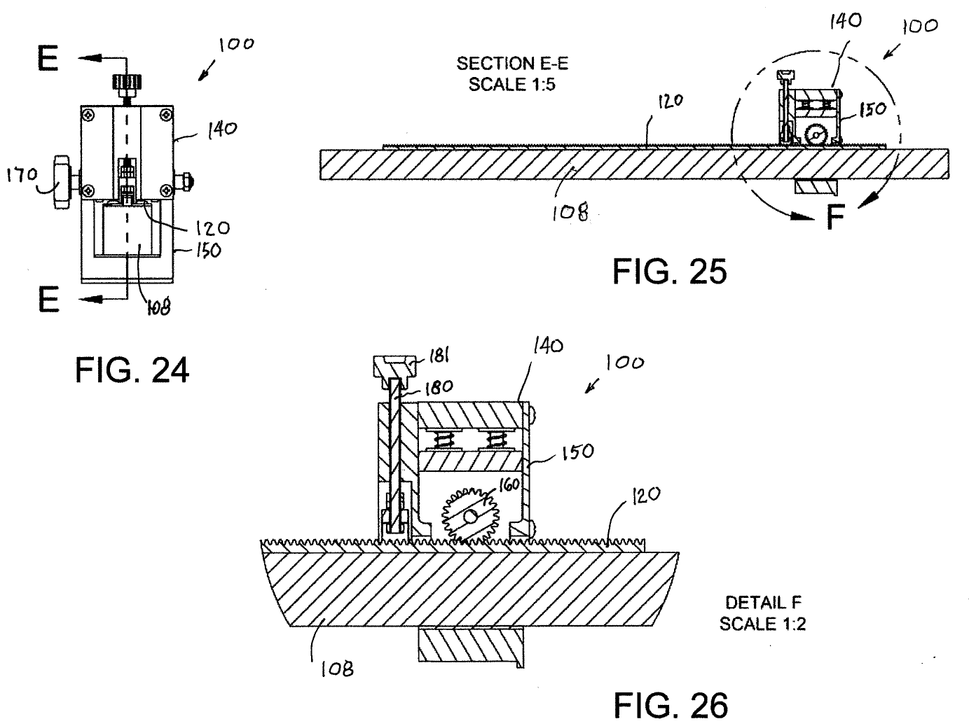

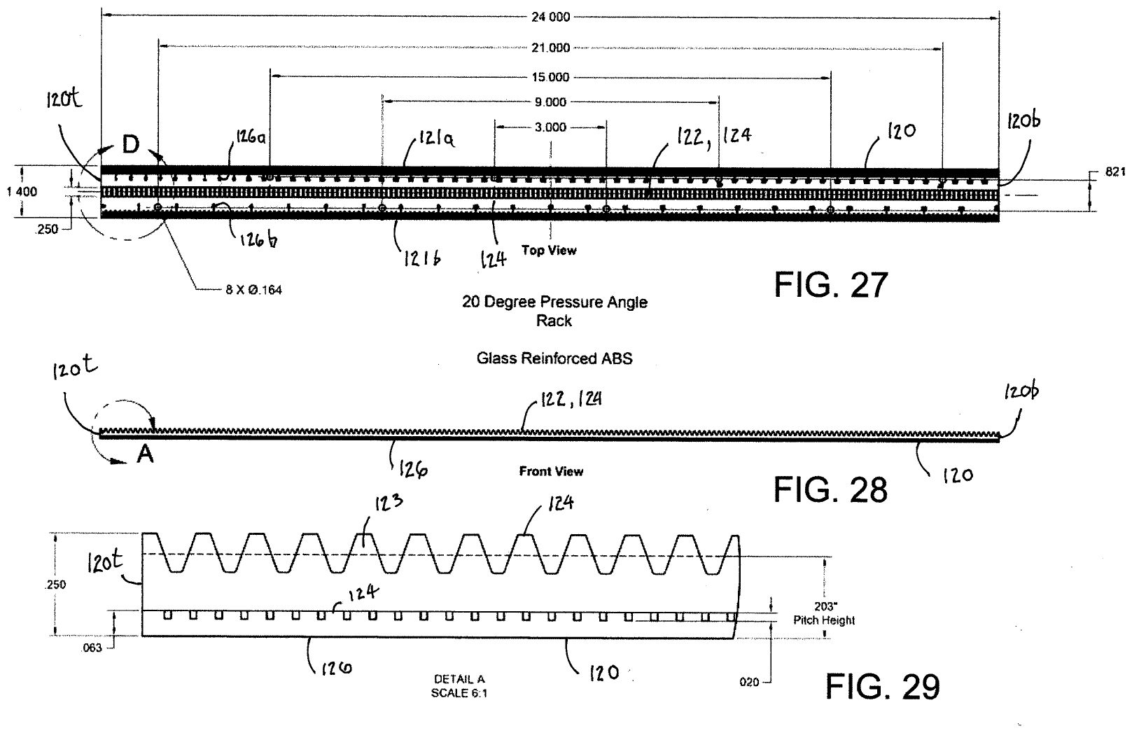

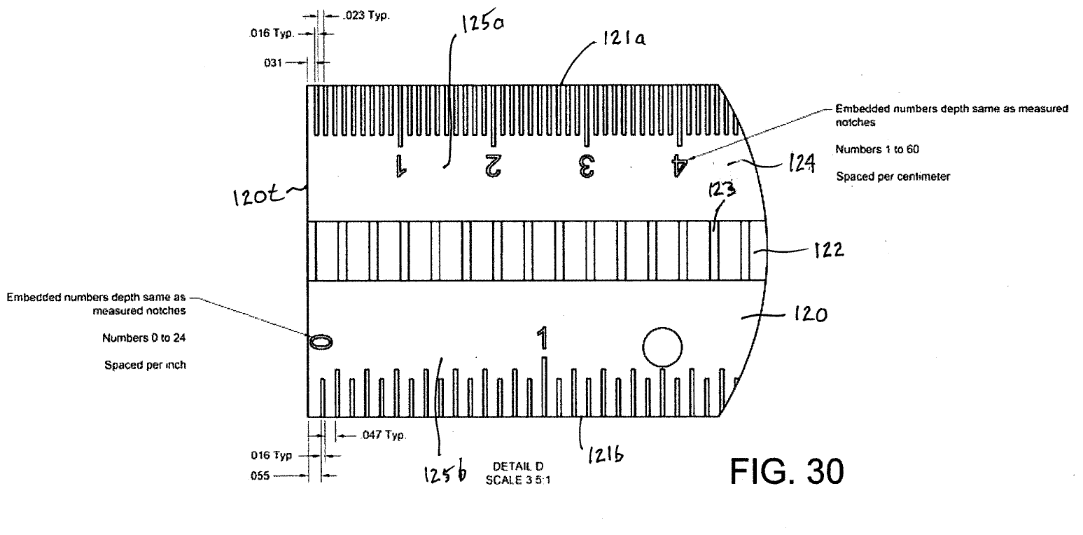

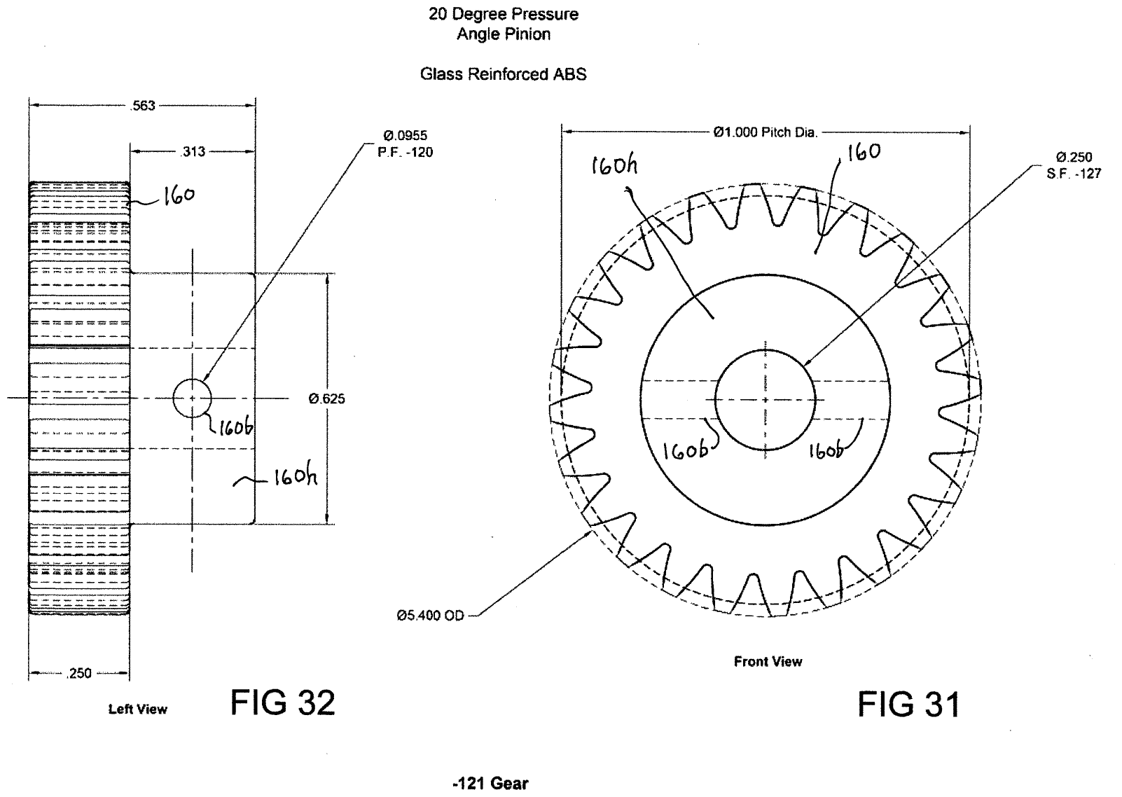

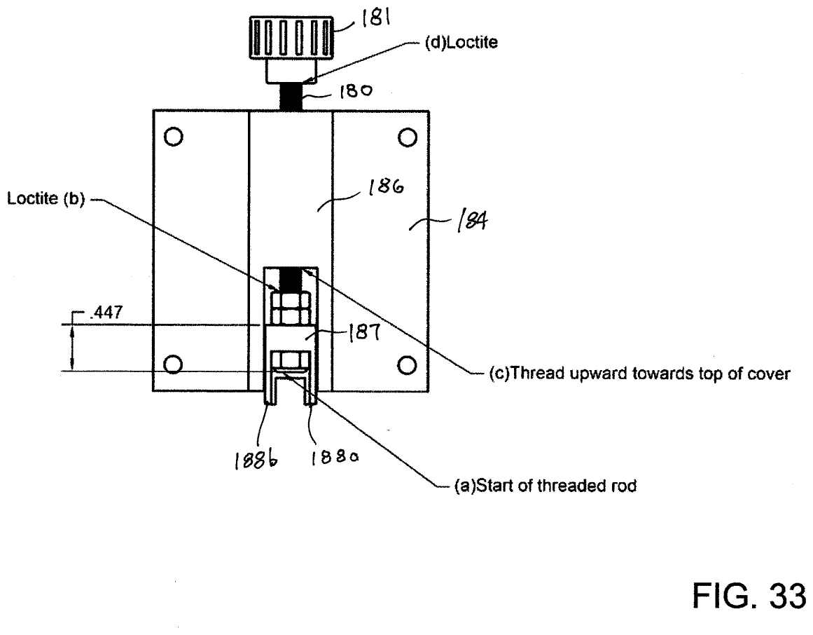

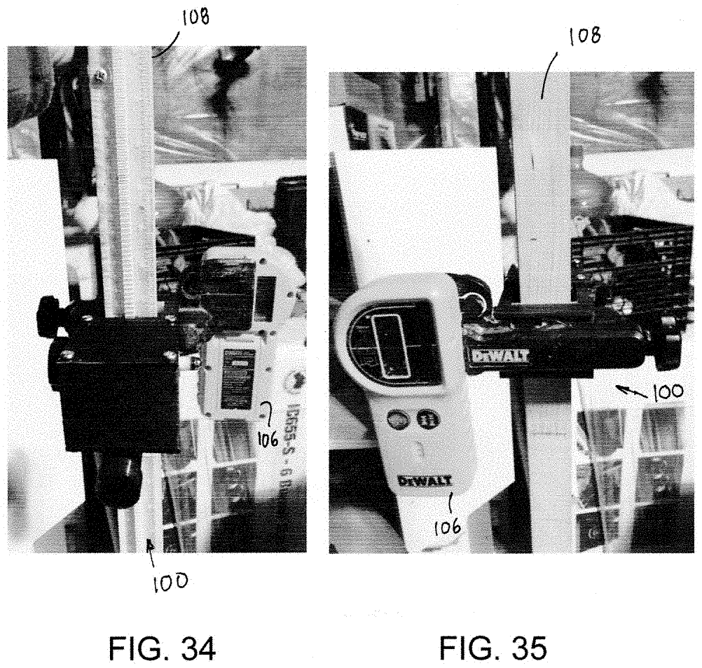

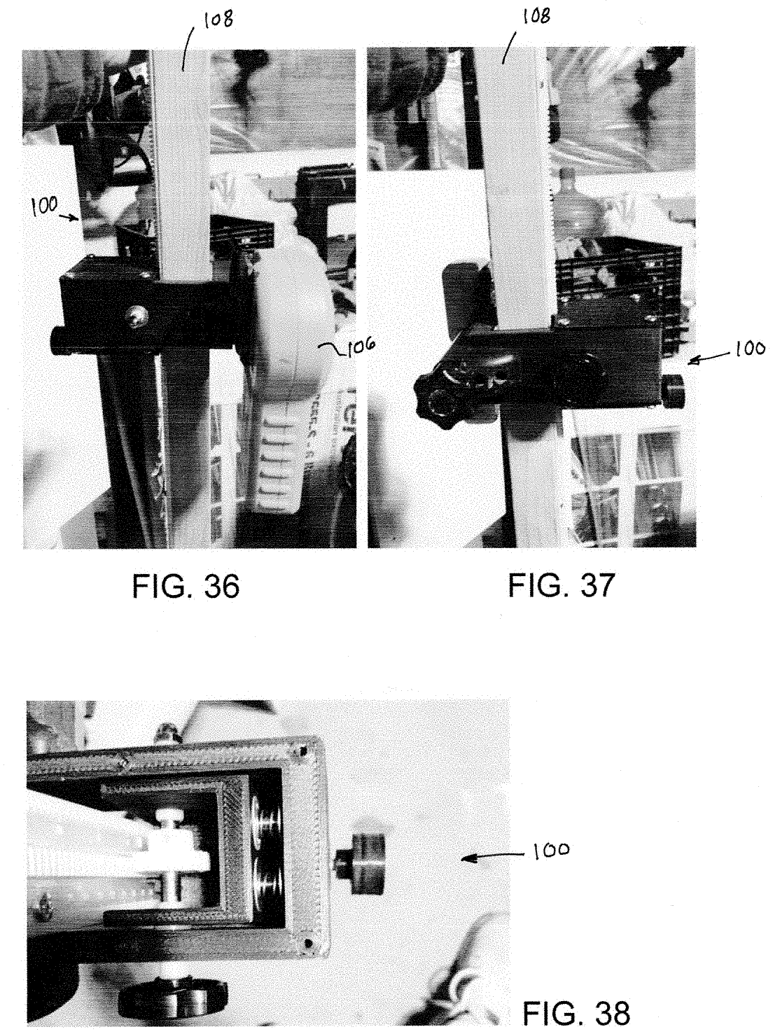

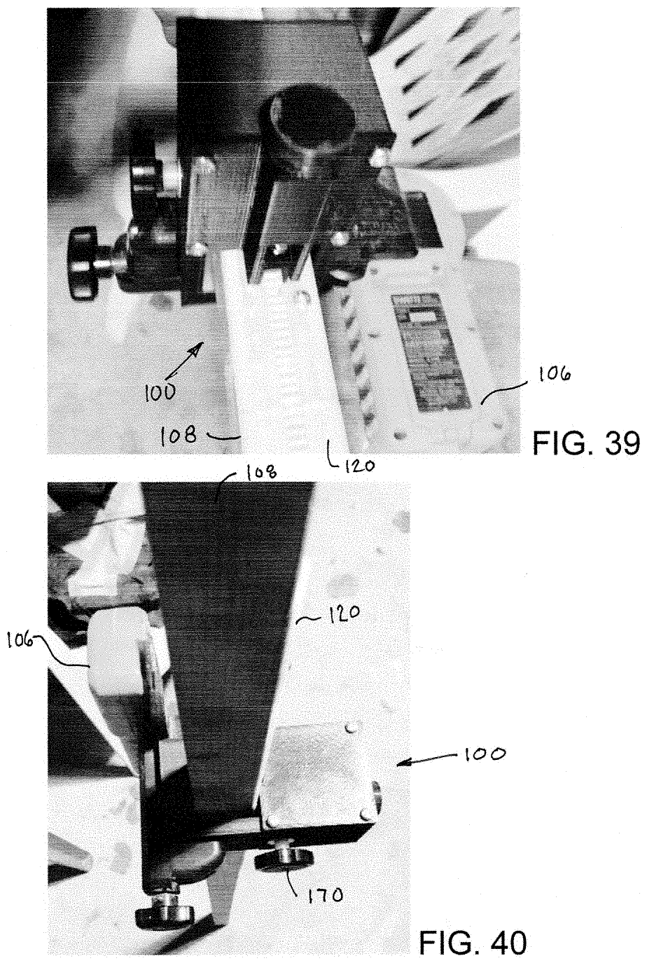

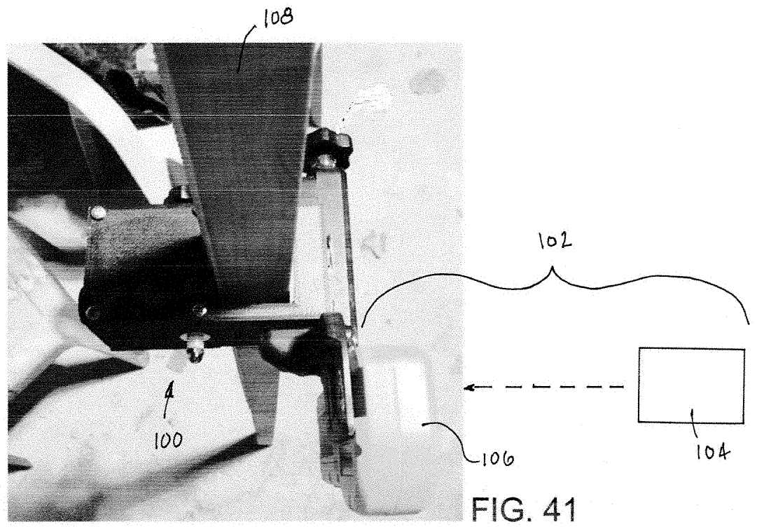

Reference will now be made to FIGS. 1 through 41, which show the first illustrated embodiment of the apparatus 100 according to the present invention.

More specifically, the present invention comprises an apparatus 100 for use with a rotary laser level system 102. The rotary laser level system 102 has a rotary laser level 104 that shines a laser light outwardly in a horizontal plane. The laser light is received by a remote re-positionable laser sensor 106. The apparatus 100 is for mounting the remote re-positionable laser sensor 106 in selectable elevation on a manually relocatable rod 108, which may be known as a surveyor's rod, so that the remote re-positionable laser sensor 106 is at a predetermined selected elevation, as determined by the horizontal plane of the laser light. It should be understood that the manually relocatable rod 108 may comprises a handy piece of “two by two” lumber perhaps four to six feet long, which would be readily available on most any construction site, or may comprise a preformed rod made of any suitable material such as wood, metal, plastic, a composite material, or the like.

In brief, the apparatus 100 comprises a track 120 having a gear rack 122, and a sensor carrier 140 that comprises a housing 150, a wheel 160 (specifically a pinion gear 160 in the first illustrated embodiment), and means 170 for selectively imparting rotation of the pinion gear 160. In use, the remote re-positionable laser sensor 106 clamps onto the housing 150, typically by way of a clamp that is included with the remote re-positionable laser sensor 106.

More specifically, the apparatus 100 comprises a track 120 presenting an outer face 124 and a rod-engaging face 126, and has a length “L” extending between a top end 120t and a bottom end 120b. As illustrated, the gear rack 122 is disposed on the outer face 124 of the track 120 so as to be operatively engageable and extending along the length of the track 120. The track 120 is mountable in fixed relation on the manually relocatable rod 108 by means of suitable threaded fasteners or any other suitable means.

The track 120 also extends between a left side edge 121a and a right side edge 121b that are straight and parallel to each other, so as to permit the track 120 to fit within the width of a conventional “two by two” piece of lumber.

In the first illustrated embodiment, the track 120 comprises a gear rack 122 having a plurality of gear teeth 123 evenly spaced one from the next. As illustrated, the gear rack 122 is disposed on the outer face 124 of the track 120 so as to be operatively engageable, and extends along the length of the track 120 between the top end 120t and the bottom end 120b of the track 120.

Further, the gear rack 122 is centrally disposed between the left side edge 121a and the right side edge 121b, and further comprises a left shoulder area 125a and a right shoulder area 125b bordering the gear rack 122. The track 120 also further comprises measuring scales on the outer face 124 of the track 120. Specifically, a first scale 126a is disposed on the left shoulder area 125a and a second scale 126b is disposed on the right shoulder area 125b.

The sensor carrier 140 is operatively mounted on the track 120 for movement along the track 120. The sensor carrier 140 is mounted in rolling and sliding relation on the track 120.

The housing 150 of the sensor carrier 140 extends between a top 150a and a bottom 150b, has a front portion 150c, a back portion 150d, a left side portion 150e and a right side portion 150f. More specifically, the front portion 150c comprises a front wall 150c, the back portion 150d comprises a back wall 150d, the left side portion 150e comprises a left side wall 150e and the right side portion 150f comprises a right side wall 150f. The front portion 150c, the back portion 150d, the left side portion 150e and the right side portion 150f together define a throughpassage 159 from the top 150a of the housing 150 to the bottom 150b of the housing 150. The track 120 and the manually relocatable rod 108 each extend through the throughpassage 159 and the housing 150 surrounds the track 120, and the sensor carrier 140 moves in rolling and sliding relation track 120 and the manually relocatable rod 108. A small plate 149 made of a material such as a ultra-high molecular-weight (UHMW) material, such as ultra-high molecular-weight polyethylene, is secured to the inner face of the back wall 150d to provide a low friction sliding surface along which the manually relocatable rod 108 can readily move, as the sensor carrier 140 Is selectively moved to various desired positions during use.

In the first illustrated embodiment, the housing 150 comprises an outer housing 150o, and the apparatus 100 further comprises an inner housing 150i mounted within the outer housing 150o. The outer housing 150o comprises a unitary structure for the sake of manufacturing efficiency and structural strength.

The inner housing 150i is mounted in spring biased relation on the outer housing 150o so as to be disposed forwardly of the track 120. The inner housing 150i is substantially “U”-shaped having a base 151 interconnecting two arms 152, and the base 151 is disposed adjacent the front wall 150c and the two arms 152 extend towards the track 120. There is at least one biasing spring 153, and in the first illustrated embodiment four biasing springs 153, operatively mounted between the inner housing 150i and the outer housing 150o, so as to bias the inner housing 150i towards the track 120, and therefore bias the pinion gear 160, into secure engagement with the track 120. The biasing springs 153 are retained in surrounding relation around robust posts 154 that are press fit into cooperating apertures 154a in the front wall 150c of the outer housing 150o and press fit into cooperating apertures 154b in the base 151 of the “U”-shaped inner housing 150i. The ends of the biasing springs 153 are received contact co-operating washers 155 that bear against the front wall 150c of the outer housing 150o and the base 151 of the “U”-shaped inner housing 150i.

In general, the pinion gear 160 is mounted on the housing 150 in rotatable relation about a main axis “M”, and in the first illustrated embodiment, the pinion gear 160 is mounted on the outer housing 150o and the inner housing 150i. More specifically, the pinion gear 160 is securely mounted on a drive shaft 156 for rotation therewith and is secured in place by a pin 156p press fit through opposed bore holes 160b in the hub 160h of the pinion gear 160 and a bore hole 156b in the drive shaft 156. The drive shaft 156 is mounted in freely rotatable relation on the inner housing 150i by a pair of low friction bushings 157b in co-operating apertures 157, and extends through a pair of opposed elongate openings 158 in the outer housing 150o, specifically in the left side wall 150e and the right side wall 150f, to thereby accommodate movement of the inner housing 150i, and therefore movement of the pinion gear 160 with respect to the track 120. Accordingly, the biasing springs 153 bias the pinion gear 160 securely into engagement with the gear teeth 123 of the track 120. As can be readily seen, the pinion gear 160 is operatively engaged on the outer face 124 of the track 120.

There is also means 170 for selectively imparting rotation of the pinion gear 160 about the main axis “M” to thereby cause the sensor carrier 140 to move along the track 120. As can be readily seen in the Figures, the means 170 for permitting rotation of the pinion gear 160 about the main axis “M” comprises a handle 170 securely connected to the drive shaft 156 for rotation therewith.

In the above-described manner, the pinion gear 160 is operatively engaged on the track 120 such that rotation of the pinion gear 160 via the handle causes movement of the pinion gear 160 along the gear rack 122, and therefore along the track 120.

The apparatus 100 further comprises a threaded securing fastener 180 having a user engagement end 180a and a track engaging end 180b. The threaded securing fastener 180 is threadibly engaged in the sensor carrier 140 for selectively locking the sensor carrier 140 at a selected elevation with respect to the track 120. The sensor carrier 140 further comprises a top cover 182 and a bottom cover 184, and the threaded securing fastener 180 is threadibly engaged in one of the top cover 182 and the bottom cover 184, and in the first illustrated embodiment, is engaged in threaded relation in a co-operating threaded bore hole 185 in an extension portion 186 in the bottom cover 184.

The threaded securing fastener 180 includes a track-engaging bridge 187 comprising a left leg 188a and a right leg 188b interconnected by a base portion 189. The left leg 188a engages the left shoulder area 125a of the track 120 and the right leg 188b engages the right shoulder area 125b of the track 120. Accordingly, the threaded securing fastener 180 does not press on the gear track 120.

In use, the track 120 is secured to a manually relocatable rod 108, such as a two by two piece of lumber 108, by a plurality of threaded fasteners 109. The threaded fasteners 109 maybe countersunk so as to not protrude above the level of the track 120, and thereby not interfere with the movement of the sensor carrier 140. The sensor carrier 140 is slipped over one of the ends of the two by two 108, and is moved along the two by two 108 until the track 120 is engaged. At that point, the pinion gear 160 engages the gear track 120.

The remote re-positionable laser sensor 106 clamps onto the housing 150, typically by way of a clamp that is included with the remote re-positionable laser sensor 106.

The main handle 170 can be used (rotated) to move the sensor carrier 140 along the track 120. More specifically, when the main handle 170 is rotated, the pinion gear 160 correspondingly rotates, thereby moving the pinion gear 160 along the track 120, and correspondingly moving the sensor carrier 140 along the track 120 to a selected position. The sensor carrier 140 can be locked in place using the threaded securing fastener 180, and more specifically by turning the small handle 181 on the threaded security fastener 180.

It should also be understood that the threaded securing fastener 180 could be configured for selectively locking the sensor carrier with respect to the manually relocatable rod 108.

In another aspect, the present invention provides a kit comprising a track 120 presenting an outer face 124 and a rod-engaging face 126, and having a length “L” extending between the top end 120t and the bottom end 120b. A sensor carrier 140 is operatively mounted on the track 120 having a gear rack 122, for movement along the track 120. The sensor carrier 140 comprises a housing 150; a wheel 160 (specifically a pinion gear 160 in the first illustrated embodiment), mounted on the housing 150 in rotatable relation about a main axis “M”. The pinion gear 160 is operatively engaged on the track 120 such that rotation of the pinion gear 160 causes movement of the housing 150 along the track 120.

There is also means 170 for selectively imparting rotation of the pinion gear 160 about the main axis “M” to thereby cause the sensor carrier 140 to move along the track 120. As can be readily seen in the Figures, the means 170 for permitting rotation of the pinion gear 160 about the main axis “M” comprises a handle 170 securely connected to the drive shaft 156 for rotation therewith. In use, when the handle 170 is rotated, the pinion gear 160 correspondingly rotates, thereby moving the pinion gear 160 along the track 120, and correspondingly moving the sensor carrier 140 along the track 120 to a selected position.

In another aspect, the present invention comprises a novel assembly for use with a rotary laser level system 102 having a rotary laser level 104 that shines a laser light that is received by remote re-positionable laser sensor 106, for mounting the re-positionable laser sensor 106 in selectable elevation on a manually relocatable rod 108, as described previously. The assembly comprising a track 120, a sensor carrier 140 operatively mounted on the track 120 for movement along the track 120. The sensor carrier 140 comprises a housing 150 and a wheel 160, such as a pinion gear 160, mounted on the housing 150 in rotatable relation about a main axis “M”. The wheel 160 is operatively engaged on the track 120 such that rotation of the wheel 160 causes movement of the wheel 160 along the track 120. There is also means 170, such as handle 170, for selectively imparting rotation of the wheel 160 about the main axis “M” to thereby cause the sensor carrier 140 to move along the track 120. In use, when the handle 170 is rotated, the wheel 160 correspondingly rotates, thereby moving the wheel 160 along the track 120, and correspondingly moving the sensor carrier 140 along the track 120 to a selected position.

In another aspect, the present invention comprises a novel combination of a track 120 and a sensor carrier 140 operatively mounted on the track 120 for movement along the track 120. The sensor carrier 140 comprises a housing 150 and a wheel 160, such as a pinion gear 160, mounted on the housing 150 in rotatable relation about a main axis “M”. The wheel 160 is operatively engaged on the track 120 such that rotation of the wheel 160 causes movement of the wheel 160 along the track 120. There is also means 170, such as handle 170, for selectively imparting rotation of the wheel 160, such as a pinion gear 160, about the main axis “M” to thereby cause the sensor carrier 140 to move along the track 120. In use, when the handle 170 is rotated, the wheel 160 correspondingly rotates, thereby moving the wheel 160 along the track 120, and correspondingly moving the sensor carrier 140 along the track 120 to a selected position.

In another aspect, the present invention comprises a novel method of positioning a remote re-positionable laser sensor 106 for receiving laser light from a rotary laser level 104. The method comprises the steps of positioning a track 120 in a generally upright orientation; rotating a wheel 160 operatively engaged with the track 120 to cause movement of the wheel 160 along the track 120, and thereby move the sensor along the track 120 to a selected position to thereby receive the laser light.

In another aspect, the present invention comprises a novel track 120 for use in conjunction with a rotary laser level system 102. The track 120 comprises a main body 127 extending between a top end 120t and a bottom end 120b. The track 120 also has a gear rack 122, and presents an outer face 124 and a rod-engaging face 126.

In another aspect, the present invention comprises a novel system comprising a track 120 and a wheel 160, such as a pinion gear 160, mounted on a housing 150 in rotatable relation about a main axis “M”. The wheel 160 is operatively engaged on the track 120 such that rotation of the wheel 160 causes movement of the wheel 160 along the track 120. There is also means 170, such as handle 170, for selectively imparting rotation of the wheel 160 about the main axis “M” to thereby cause the sensor carrier 140 to move along the track 120. In use, when the handle 170 is rotated, the wheel 160 correspondingly rotates, thereby moving the wheel 160 along the track 120, and correspondingly moving the sensor carrier 140 along the track 120 to a selected position.

In another aspect, the present invention comprises a novel adjustment system for facilitating the movement of a sensor carrier 140 along the track 120 to a selected position. The adjustment system comprising a wheel 160, such as a pinion gear 160, mounted on a housing 150 in rotatable relation about a main axis “M”. The wheel 160 is operatively engaged on the track 120 such that rotation of the wheel 160 causes movement of the wheel 160 along the track 120. There is also means 170, such as handle 170, for selectively imparting rotation of the wheel 160 about the main axis “M” to thereby cause the sensor carrier 140 to move along the track 120. In use, when the handle 170 is rotated, the wheel 160 correspondingly rotates, thereby moving the wheel 160 along the track 120, and correspondingly moving the sensor carrier 140 along the track 120 to a selected position.

In another aspect, the present invention comprises a novel assembly for use with a rotary laser level system 102 having a rotary laser level 104 that shines a laser light that is received by remote re-positionable laser sensor 106, for mounting the re-positionable laser sensor 106 in selectable elevation on a manually relocatable rod.

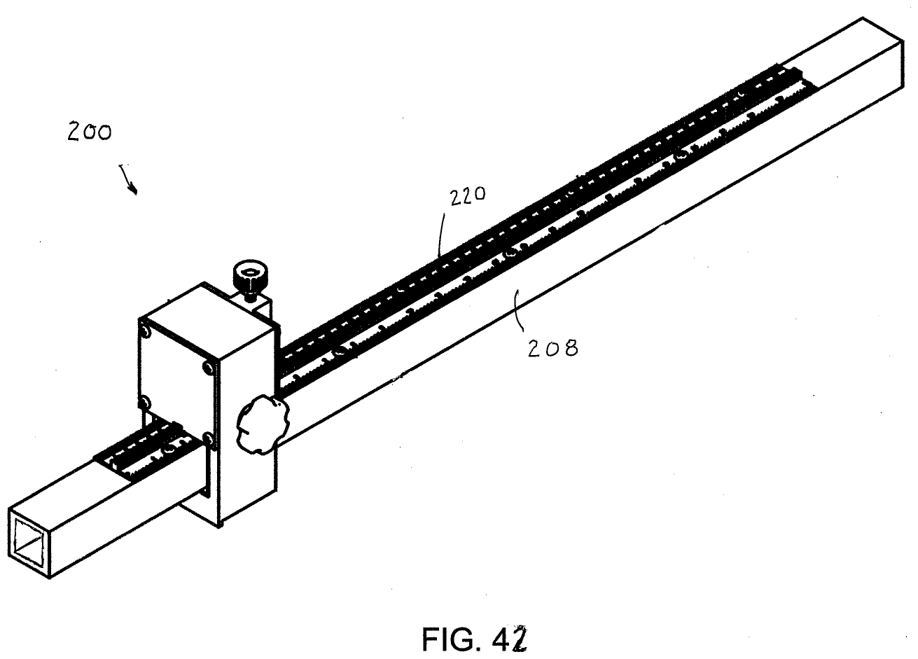

Reference will now be made to FIG. 42, which shows the second illustrated embodiment of the apparatus 200 according to the present invention. The second illustrated embodiment apparatus 200 is similar to the first illustrated embodiment 100 except that manually relocatable rod 108 found in the first illustrated embodiment has been replaced by a main body member 208 in the second illustrated embodiment that is part of the apparatus 200 or kit. Accordingly, the main body member 208 may be of any suitable shape or material. As illustrated, the main body member 208 comprises a hollow metal tube. The track 220 may be mounted on the main body member, in a similar manner as in the first illustrated embodiment, or the track 220 may be integrated into the main body member 208, as illustrated.

The apparatus 200 is for use with a rotary laser level system 202 having a rotary laser level 204 that shines a laser light that is received by a remote re-positionable laser sensor 206, for permitting selective re-positioning of the re-positionable laser sensor 206 in selectable elevation.

In another aspect, the assembly comprises a main body member 208, a track 220, and a sensor carrier 240 operatively mounted on the track 220 for movement along the track 220. The sensor carrier 240 comprises a housing 250, and a wheel 260, such as a pinion gear 260, mounted on the housing 250 in rotatable relation about a main axis “M”. The wheel 260, such as a pinion gear 260, is operatively engaged on the track 220 such that rotation of the wheel 260 causes movement of the wheel 260 along the track 220. There is also means 270, such as a handle 270, for selectively imparting rotation of the wheel 260 about the main axis “M” to thereby cause the sensor carrier 240 to move along the track 220. In use, when the handle 270 is rotated, the wheel 260 correspondingly rotates, thereby moving the wheel 260 along the track 220, and correspondingly moving the sensor carrier 240 along the track 220 to a selected position.

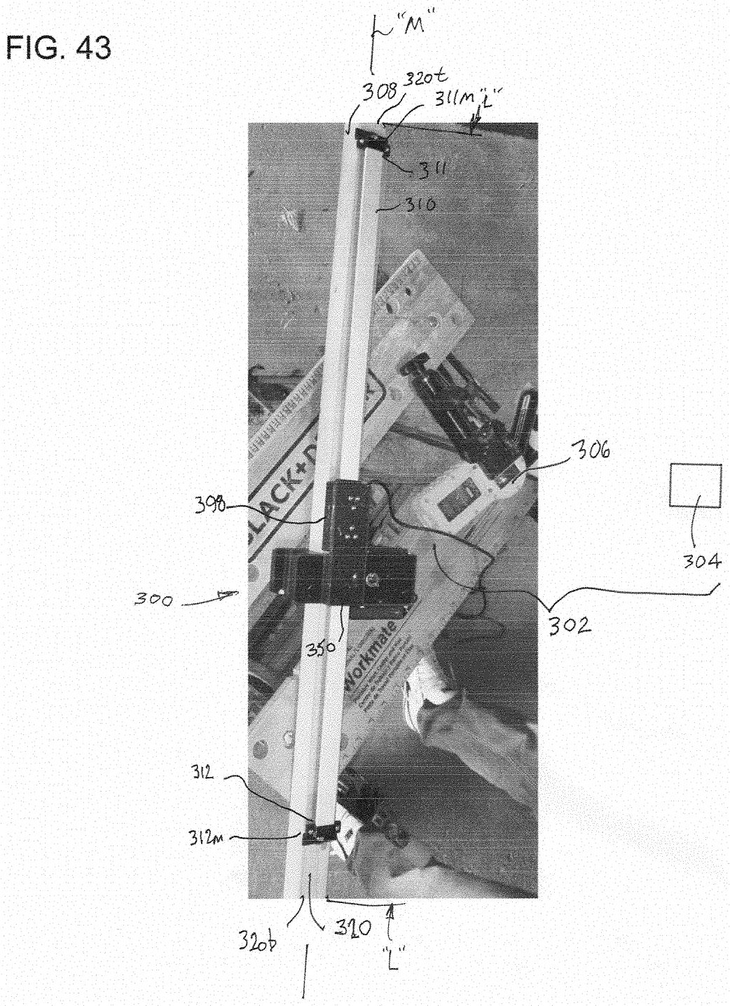

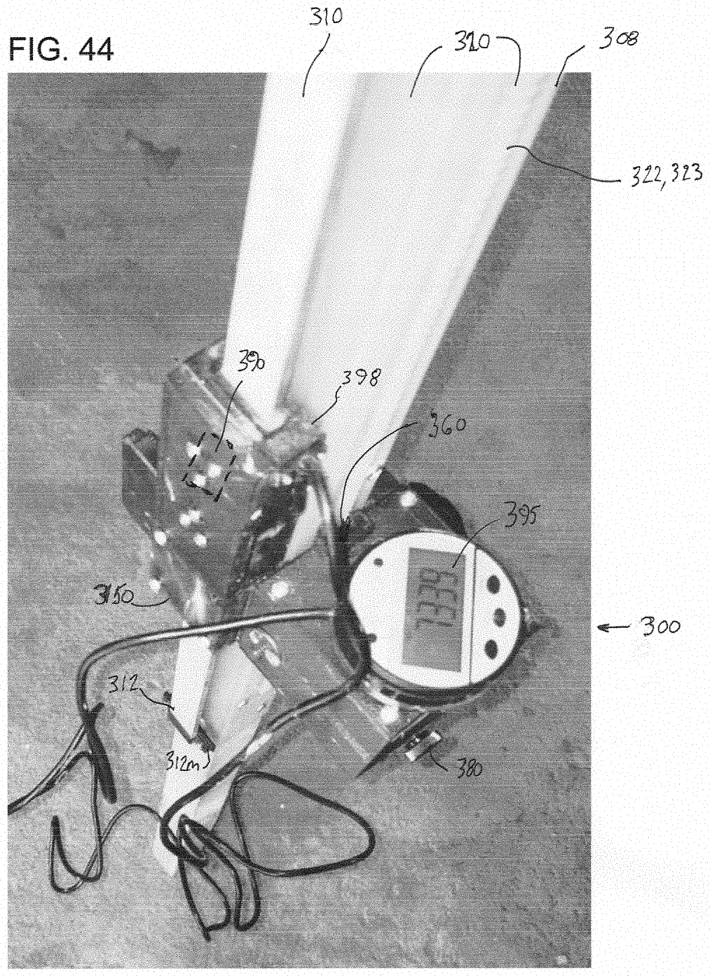

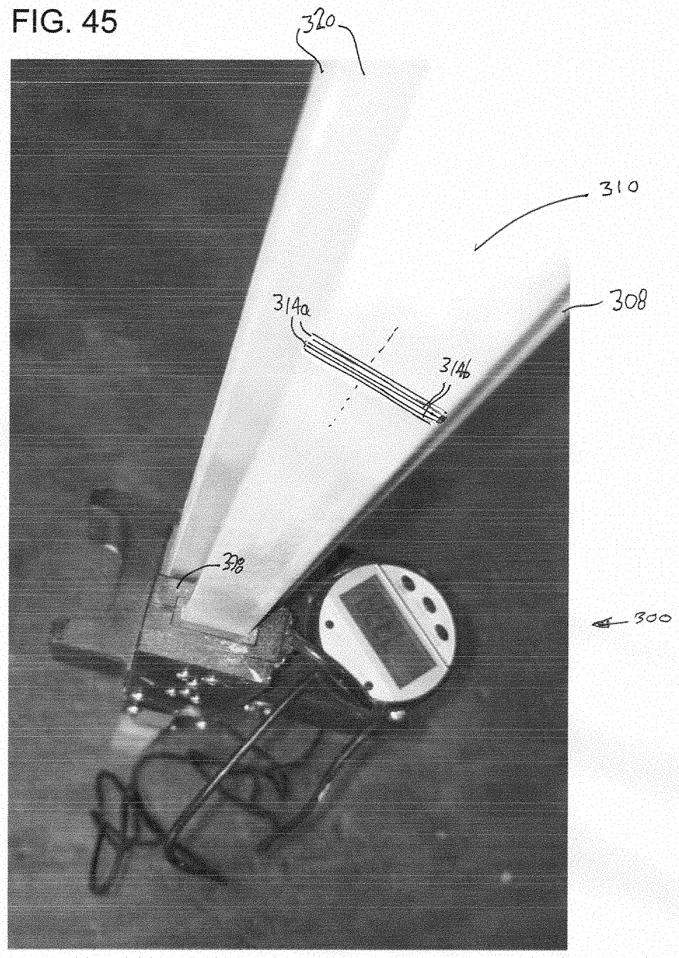

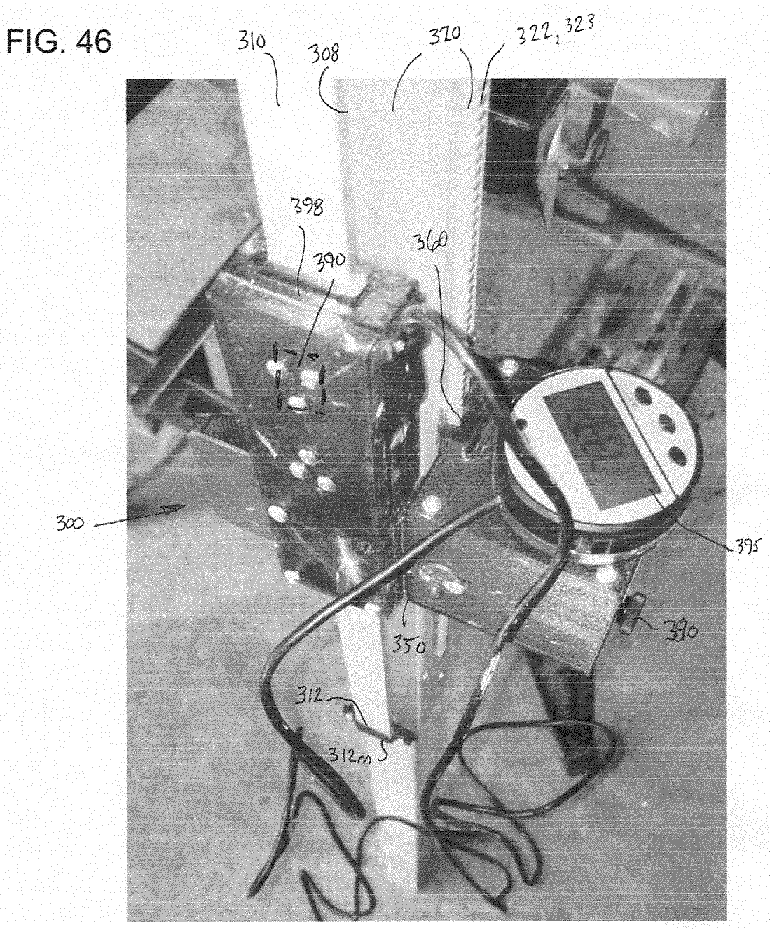

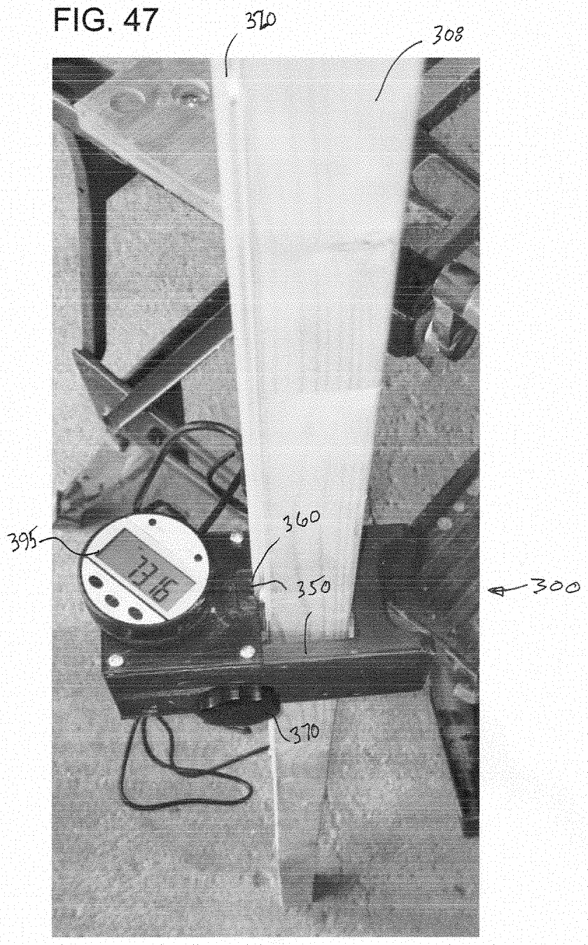

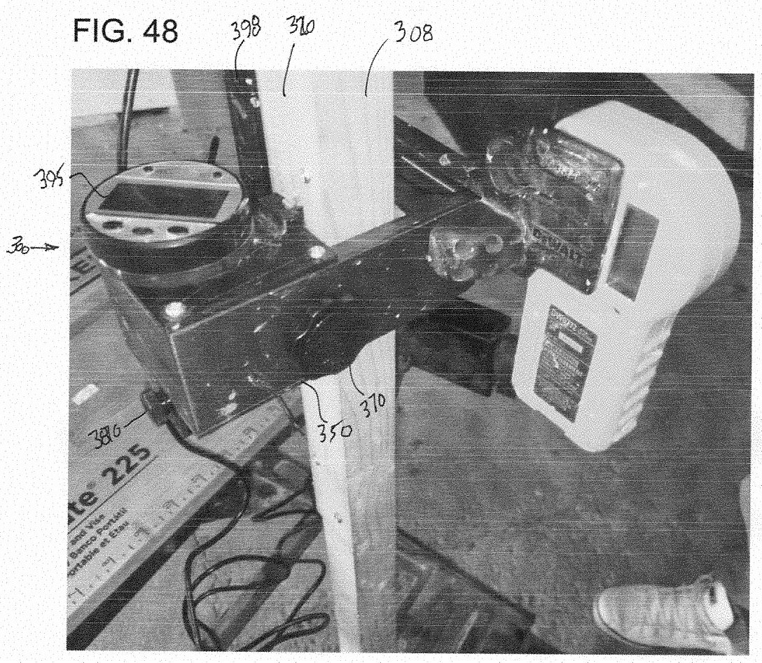

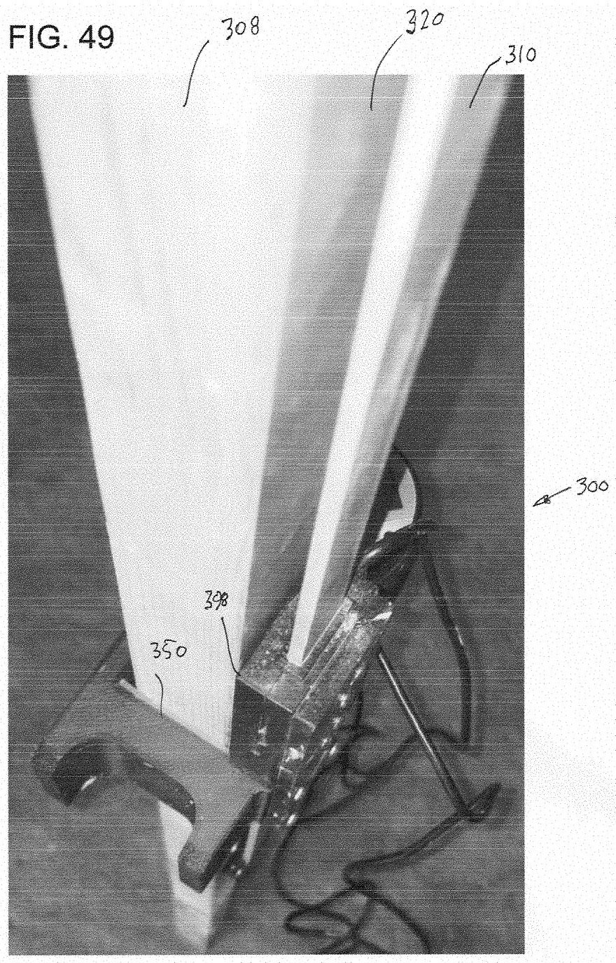

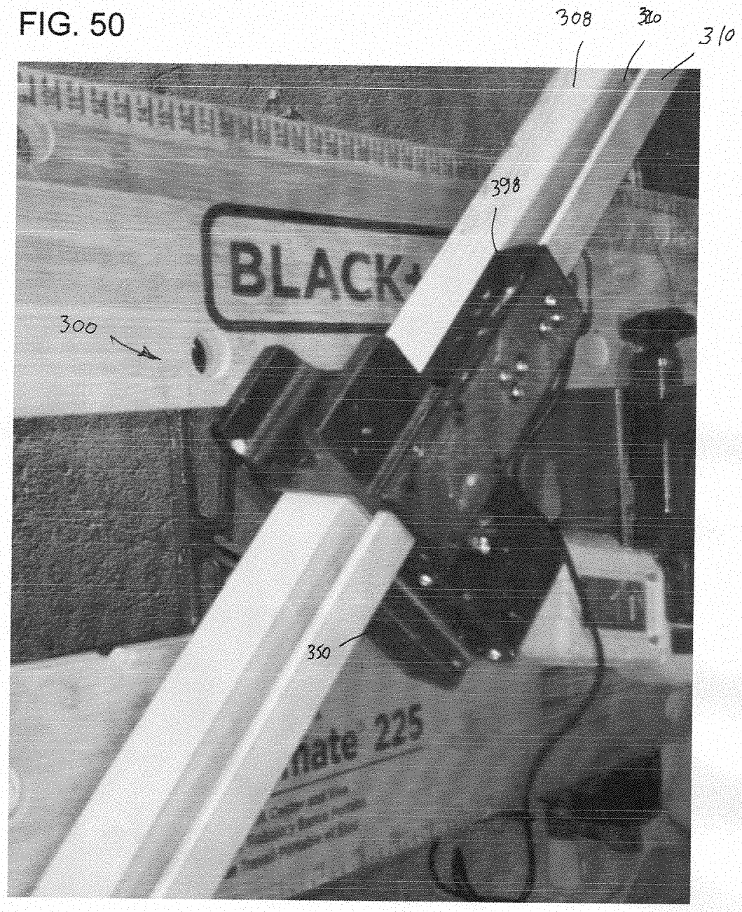

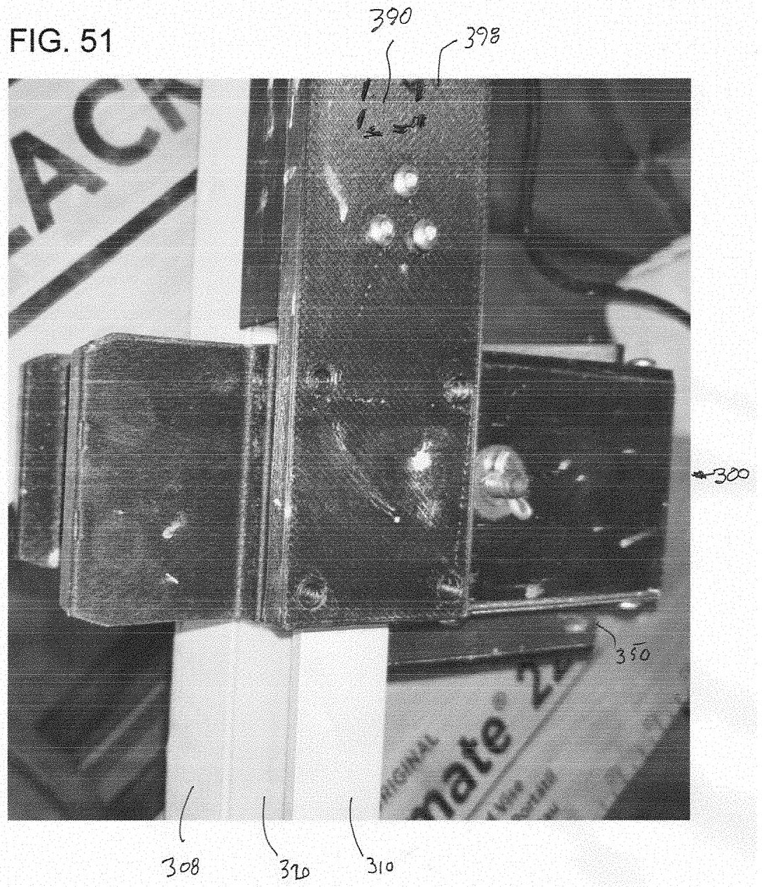

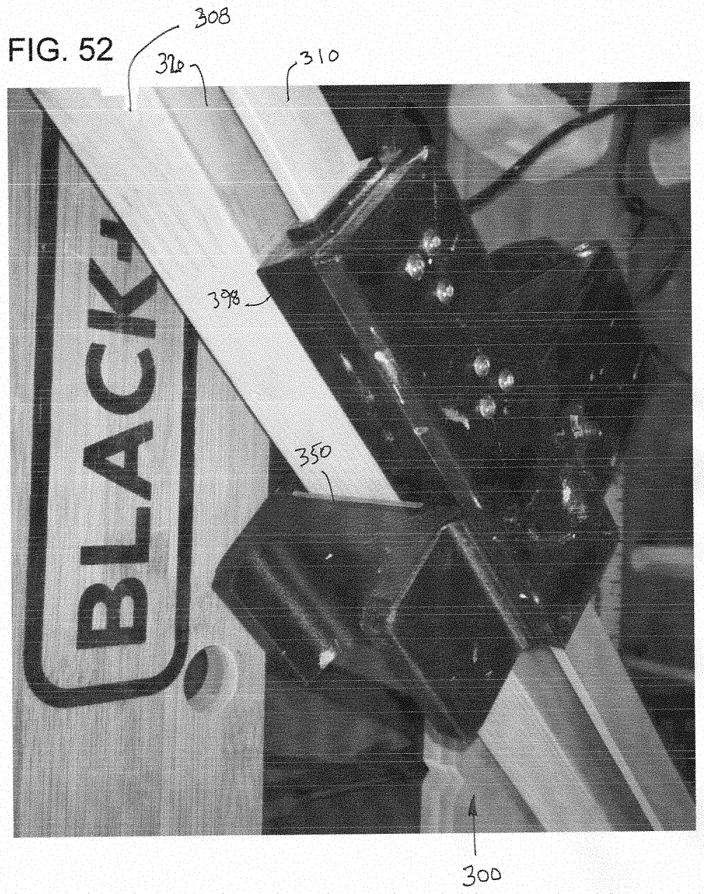

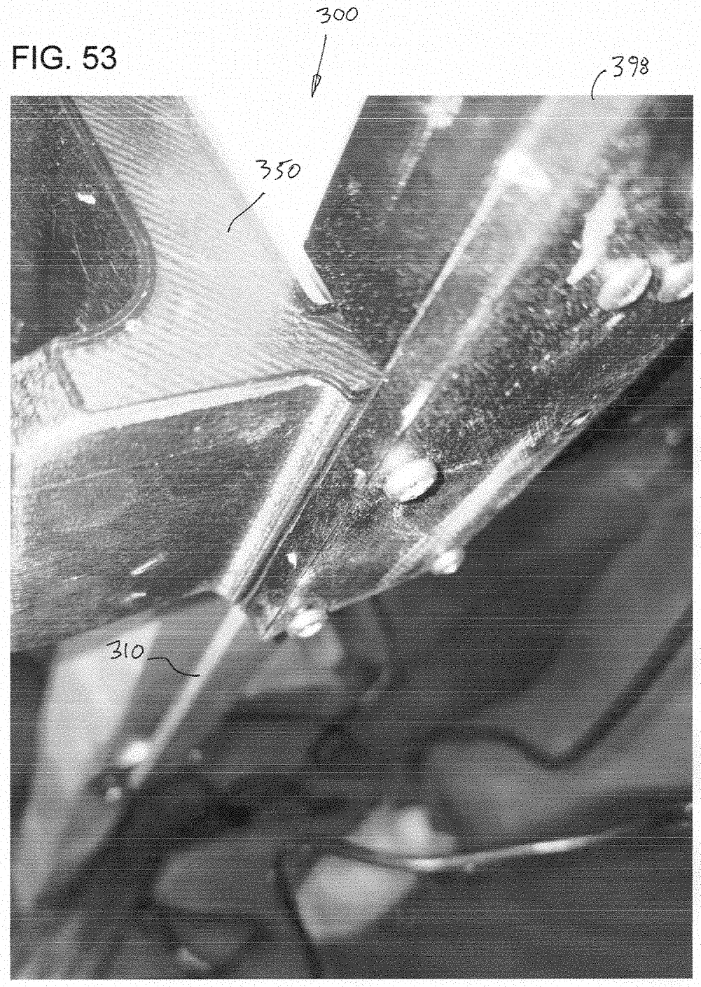

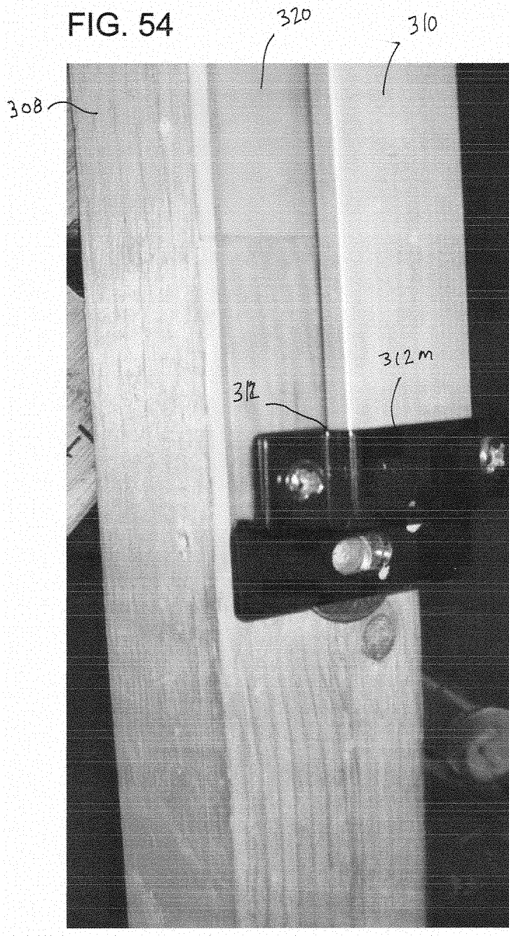

Reference will now be made to FIGS. 43 through 54, which show the third illustrated embodiment of the apparatus 300 according to the present invention.

More specifically, the present invention comprises an apparatus 300 for use with a rotary laser level system 302. The rotary laser level system 302 has a rotary laser level 304 that shines a laser light outwardly in a horizontal plane. The laser light is received by a remote re-positionable laser sensor 306. The apparatus 300 is for mounting the re-positionable laser sensor 306 in selectable elevation on a manually relocatable rod 308, so that the re-positionable laser sensor 306 is at a predetermined selected elevation, as determined by the horizontal plane of the laser light. Basically, the apparatus 300 carries the re-positionable laser sensor 306. It should be understood that very often a manually relocatable rod 308 would comprises a handy piece of “two by two” (2×2) lumber perhaps four to six feet long, which would be readily available on most any construction site.

In brief, the apparatus 300 comprises a track 320 having a gear rack 322, and a sensor carrier 340 that comprises a housing 350, a wheel 360 (specifically a pinion gear 360 in the third illustrated embodiment), means 370 for selectively imparting rotation of the pinion gear 360, a measurement strip 310, a strip sensor 390 and an electronic digital readout 395. In use, the remote re-positionable laser sensor 306 clamps onto the housing 350, typically by way of a clamp that is included with the remote re-positionable laser sensor 306. The third illustrated embodiment of the apparatus 300 is very similar to the first illustrated embodiment of the apparatus 100, except that additionally the measurement strip 310, the strip sensor 390 and the electronic digital readout 395. Accordingly, the description of various parts from the first illustrated embodiment 100 will not be duplicated in the description of the third illustrated embodiment 300.

More specifically, the apparatus 300 comprises a track 320 presenting an outer face 324 and a rod-engaging face 326, and has a length “L” extending between a top end 320t and a bottom end 320b. As illustrated, the gear rack 322 is disposed on the outer face 324 of the track 320 so as to be operatively engageable and extending along the length of the track 320. The track 320 is mountable in fixed relation on the manually relocatable rod 308 by means of suitable threaded fasteners or any other suitable means. The track 320 is “L”-shaped in cross section and has a first track portion 320a and a second track portion 320b.

In the second illustrated embodiment, the track 320 comprises a gear rack 322 having a plurality of gear teeth 323 evenly spaced one from the next. As illustrated, the gear rack 322 is disposed on the outer face 324 of the track 320 so as to be operatively engageable, and extends along the length of the track 320 between the top end 320t and the bottom end 320b of the track 320.

The sensor carrier 340 is operatively mounted on the track 320 for movement along the track 320. The sensor carrier 340 is mounted in rolling and sliding relation on the track 320.

The remote re-positionable laser sensor 306 clamps onto the housing 350, typically by way of a clamp that is included with the remote re-positionable laser sensor 306.

The main handle 370 can be used (rotated) to move the sensor carrier 340 along the track 320.

It should also be understood that the threaded securing fastener 380 could be configured for selectively locking the sensor carrier with respect to the manually relocatable rod 308.

In another aspect, the present invention provides a kit that in brief comprises the track 320 having the gear rack 322, and the sensor carrier 340 that comprises the housing 350, the wheel 360 (specifically a pinion gear 360 in the third illustrated embodiment), means 370 for selectively imparting rotation of the pinion gear 360, the measurement strip 310, the strip sensor 390 and the electronic digital readout 395.

The measurement strip 310 has a top end 311 and a bottom end 312 and defines a longitudinal axis “L” extending between the top end 311 and the bottom end 312. As can be readily seen in the figures, the measurement strip 310 is mounted on the track 320 by means of a top mounting bracket 311m disposed at the top end 311 and a bottom mounting bracket 312m disposed at the bottom end 312 of the measurement strip 310, and is thereby mounted in spaced relation from the track 320. The measurement strip 310 is thereby securely connected to the track 320, and is securely connected to the track 320 in parallel relation to the track 320. As, illustrated, the track 320 is straight and the measurement strip 310 is straight.

The measurement strip 310 comprises a magnetic strip having alternatively oriented magnetic sections 314a, 314b that are oriented transversely to the longitudinal axis “L” of the measurement strip 310. The alternatively oriented magnetic sections 314a, 314b are arranged N—S,S—N,N—S,S—N, and so on.

The strip sensor 390 is mounted on the sensor carrier 340 for travel with the sensor carrier 340 along the track 320 and in adjacent relation to the measurement strip 310 for movement along the measurement strip 310. The strip sensor 390 comprises a magnetic pick-up and is for detecting changes in portions of the measurement strip 310, namely the alternatively oriented magnetic sections 314a, 314b, as the strip sensor 390 travels along the measurement strip 310 in either the direction of the longitudinal axis “L”.

It is contemplated that for measuring travel of the sensor carrier 340 along the track 320 and along the measurement strip 310, various suitable types of magnetic linear encoders could be used. Such magnetic linear encoders may employ active (magnetized) or passive (variable reluctance) scales. Relative position along the scale may be sensed using various types of sensors, such as magnetoresistive readheads, sense-coils, or Hall effect sensors. Resolutions in the order of a micrometer can readily be achieved.

A linear incremental encoder has two digital output signals, which are quadrature square waves. In quadrature squarewaves, the distance between edges of the two channels being the resolution of the encoder. A reference mark or index pulse is also output in digital form, as a pulse that is one to four units-of-resolution wide. The output signals may be directly transmitted to a digital incremental encoder interface for position tracking. The phase of the two digital output signals with respect to each other can be used to determine the direction of travel of the magnetic linear encoders along the scale.

The strip sensor 390 is connected in signal transfer relation to the electronic digital readout 395 that is mounted on the sensor carrier 340 for vertical travel therewith along the track 320.

A strip sensor housing 398 is disposed in surrounding relation around the measurement strip 310 for movement along the measurement strip 310. The strip sensor 390 is mounted within the strip sensor housing 398 and is thereby protected from the potentially harsh environment of a construction site.

In use, when the sensor carrier 340 is moved along the track 320, the strip sensor 390 travels along the measurement strip 310 and produces corresponding displacement signals and transmits the corresponding displacement signals to the electronic digital readout 395 for use in displaying the elevation.

In another aspect, the present invention comprises a novel assembly for use with a rotary laser level system 302 having a rotary laser level 304 that shines a laser light that is received by a remote re-positionable laser sensor 306, for mounting the re-positionable laser sensor 306 in selectable elevation on a manually relocatable rod 308. The assembly comprises a track 320 and a sensor carrier 340 operatively engageable with the track 320 for travel along the track 320. The remote re-positionable laser sensor 306 is mounted on the sensor carrier 340 for travel with the sensor carrier 340 along the track 320. There is also a measurement strip 310 mounted on the manually relocatable rod 308, and a strip sensor 390 and an electronic digital readout 395 mounted on the sensor carrier 340 for travel with the sensor carrier 340 along the track 320 and in adjacent relation to the measurement strip 310 for movement along the measurement strip 310, for detecting changes in portions of the measurement strip 310 as the strip sensor 390 travels along the measurement strip 310. The strip sensor 390 is connected in signal transfer relation to the electronic digital readout 385. In use, when the sensor carrier 340 is moved along the track 320, the strip sensor 390 travels along the measurement strip 310 and produces corresponding displacement signals and transmits the corresponding displacement signals to the electronic digital readout 395 for use in displaying the elevation.

In another aspect, the present invention comprises a novel combination of a main body member 308, a track 320, and a sensor carrier 340 operatively mounted on the track 320 for movement along the track 320. The sensor carrier 340 comprises a housing 350, a wheel 360, such as a pinion gear 360, mounted on the housing 350 in rotatable relation about a main axis “M”. The wheel 360 is operatively engaged on the track 320 such that rotation of the wheel 360 causes movement of the wheel 360 along the track 320. There is also means 370, such as handle 370, for selectively imparting rotation of the wheel 360 about the main axis “M” to thereby cause the sensor carrier 340 to move along the track 320. In use, when the handle 370 is rotated, the wheel 360 correspondingly rotates, thereby moving the wheel 360 along the track 320, and correspondingly moving the sensor carrier 340 along the track 320 to a selected position.

In another aspect, the present invention comprises a novel combination of a track 320 and a sensor carrier 340 operatively engageable with the track 320 for travel along the track 320. The remote re-positionable laser sensor 306 is mounted on the sensor carrier 340 for travel with the sensor carrier 340 along the track 320. There is also a measurement strip 310 mounted on the manually relocatable rod 308, and a strip sensor 390 and an electronic digital readout 395 mounted on the sensor carrier 340 for travel with the sensor carrier 340 along the track 320 and in adjacent relation to the measurement strip 310 for movement along the measurement strip 310, for detecting changes in portions of the measurement strip 310 as the strip sensor 390 travels along the measurement strip 310. The strip sensor 390 is connected in signal transfer relation to the electronic digital readout 395. In use, when the sensor carrier 340 is moved along the track 320, the strip sensor 390 travels along the measurement strip 310 and produces corresponding displacement signals and transmits the corresponding displacement signals to the electronic digital readout 395 for use in displaying the elevation.

In another aspect, the present invention comprises a novel assembly for use with a rotary laser level system 302 having a rotary laser level 304 that shines a laser light that is received by a remote re-positionable laser sensor 306, for permitting selective re-positioning of the re-positionable laser sensor 306 in selectable elevation. The apparatus comprising a main body member 308, a track 320, and a sensor carrier 340 operatively engageable with the track 320 for travel along the track 320. The remote re-positionable laser sensor 306 is mounted on the sensor carrier 340 for travel with the sensor carrier 340 along the track 320. There is also a measurement strip 310 mounted on the manually relocatable rod 308, and a strip sensor 390 and an electronic digital readout 395 mounted on the sensor carrier 340 for travel with the sensor carrier 340 along the track 320 and in adjacent relation to the measurement strip 310 for movement along the measurement strip 310, for detecting changes in portions of the measurement strip 310 as the strip sensor 390 travels along the measurement strip 310. The strip sensor 390 is connected in signal transfer relation to the electronic digital readout 395. In use, when the sensor carrier 340 is moved along the track 320, the strip sensor 390 travels along the measurement strip 310 and produces corresponding displacement signals and transmits the corresponding displacement signals to the electronic digital readout 395 for use in displaying the elevation.

In another aspect, the present invention comprises a novel combination of a main body member 308, a track 320, and a sensor carrier 340 operatively engageable with the track 320 for travel along the track 320. The remote re-positionable laser sensor 306 is mounted on the sensor carrier 340 for travel with the sensor carrier 340 along the track 320. There is also a measurement strip 310 mounted on the manually relocatable rod 308, and a strip sensor 390 and an electronic digital readout 395 mounted on the sensor carrier 340 for travel with the sensor carrier 340 along the track 320 and in adjacent relation to the measurement strip 310 for movement along the measurement strip 310, for detecting changes in portions of the measurement strip 310 as the strip sensor 390 travels along the measurement strip 310. The strip sensor 390 is connected in signal transfer relation to the electronic digital readout 395. In use, when the sensor carrier 340 is moved along the track 320, the strip sensor 390 travels along the measurement strip 310 and produces corresponding displacement signals and transmits the corresponding displacement signals to the electronic digital readout 395 for use in displaying the elevation.

In another embodiment of the apparatus according to the present invention, it is contemplated that the track is securely connected to the measurement strip.

In another embodiment of the apparatus according to the present invention, it is contemplated that that the track and the measurement strip are each mountable in fixed relation on the manually relocatable rod.

In another embodiment of the apparatus according to the present invention, it is contemplated that the track and the measurement strip are integrally formed each with the other.

1. An apparatus for use with a rotary laser level system having a rotary laser level that shines a laser light that is received by remote re-positionable laser sensor, for mounting the re-positionable laser sensor in selectable elevation on a manually relocatable rod, said apparatus comprising:
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

2. An apparatus according to claim 1, wherein said track comprises a gear rack.

3. An apparatus according to claim 2, wherein said gear rack is disposed on said outer face of said track so as to be operatively engageable

4. An apparatus according to claim 3, wherein said gear rack extends along the length of said track.

5. An apparatus according to claim 4, wherein said gear rack extends between the top end and the bottom end of said track.

6. An apparatus according to claim 1, wherein said gear track extends between a left side edge and a right side edge.

7. An apparatus according to claim 6, wherein said left side edge and said right side edge are substantially parallel each to the other.

8. An apparatus according to claim 7, wherein said gear rack is centrally disposed between said left side edge and said right side edge, and further comprising a left shoulder area and a right shoulder area bordering said gear rack.

9. An apparatus according to claim 5, wherein said gear rack comprises a plurality of gear teeth evenly spaced one from the next.

10. An apparatus according to claim 1, wherein said track presents an outer face.

11. An apparatus according to claim 10, further comprising a scale on said outer face of said track.

12. An apparatus according to claim 10, wherein said wheel is operatively engaged on said outer face of said track.

13. An apparatus according to claim 2, wherein said wheel comprises a pinion gear, and wherein said pinion gear is operatively engaged in said gear rack such that rotation of said pinion gear causes movement of the pinion gear along said gear rack.

14. An apparatus according to claim 1, wherein said sensor carrier is mounted in sliding relation on said track.

15. An apparatus according to claim 1, wherein said wheel is securely mounted on a drive shaft rotation therewith.

16. An apparatus according to claim 15, wherein said means for permitting rotation of said wheel about said main axis comprises a handle securely connected to said drive shaft for rotation therewith.

17. An apparatus according to claim 1, wherein said housing extends between a top and a bottom.

18. An apparatus according to claim 17, wherein said housing has a front portion, a back portion, a left side portion and a right side portion.

19. An apparatus according to claim 18, wherein said front portion, said back portion, said left side portion and said right side portion together define a throughpassage from the top of said housing to the bottom of said housing.

20. An apparatus according to claim 19, wherein said track extends through said throughpassage and said housing surrounds said track.

21. An apparatus according to claim 20, wherein said front portion comprises a front wall, said back portion comprises a back wall, said left side portion comprises a left side wall and said right side portion comprises a right side wall.

22. An apparatus according to claim 1, wherein said housing comprises an outer housing, and further comprising an inner housing mounted within said outer housing.

23. An apparatus according to claim 1, wherein said outer housing comprises a unitary structure.

24. An apparatus according to claim 23, wherein said inner housing is disposed forwardly of said track.

25. An apparatus according to claim 23, wherein said inner housing is substantially “U”-shaped having a base interconnecting two arms, and the base is disposed adjacent said front wall.

26. An apparatus according to claim 23, further comprising at least one biassing spring operatively mounted between said inner housing and said outer housing, so as to bias said wheel into secure engagement with said track.

27. An apparatus according to claim 1, further comprising a threaded securing fastener threadibly engaged in said sensor carrier for selectively locking the sensor carrier with respect to said track.

28. An apparatus according to claim 27, wherein said sensor carrier further comprises a top cover and a bottom cover, and wherein said threaded securing fastener is threadibly engaged in one of said top cover and said bottom cover.

29. An apparatus according to claim 28, wherein said threaded securing fastener includes a track-engaging bridge comprising a left leg and a right leg, and wherein said left leg engages said left shoulder area of said track and said right leg engages said right shoulder area of said track.

30. An apparatus according to claim 1, wherein said track presents a rod-engaging face and said track is securable to said manually relocatable rod with said rod-engaging face against said manually relocatable rod.

31. An apparatus according to claim 1, wherein said track has a length extending between a top end and a bottom end.

32. A kit comprising:
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

33. An assembly for use with a rotary laser level system having a rotary laser level that shines a laser light that is received by remote re-positionable laser sensor, for mounting the re-positionable laser sensor in selectable elevation on a manually relocatable rod, said assembly comprising:
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

34. In combination:
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

35. A method of positioning a remote re-positionable laser sensor for receiving laser light from a rotary laser level, said method comprising the steps of:
positioning a track in a generally upright orientation;
rotating a wheel operatively engaged with said track to cause movement of said wheel along said track, and thereby move said sensor along said track to a selected position to thereby receive said laser light.

36. A track for use in conjunction with a rotary laser level system, said track comprising:
a main body extending between a top end and a bottom end, and having a gear rack, and presenting an outer face and a rod-engaging face.

37. A track system comprising:
a track;
a wheel mounted on a housing in rotatable relation about a main axis, wherein said wheel is operatively engaged on said track such that rotation of said wheel causes movement of said wheel along said track;
means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

38. An adjustment system for facilitating the movement of a sensor carrier along said track to a selected position, said adjustment system comprising:
a wheel mounted on a housing in rotatable relation about a main axis, wherein said wheel is operatively engaged on said track such that rotation of said wheel causes movement of said wheel along said track;
means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

39. An apparatus for use with a rotary laser level system having a rotary laser level that shines a laser light that is received by a remote re-positionable laser sensor, for permitting selective re-positioning of the re-positionable laser sensor in selectable elevation, said apparatus comprising:
a main body member;
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

40. A kit comprising:
a main body member;
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

41. An assembly for use with a rotary laser level system having a rotary laser level that shines a laser light that is received by remote re-positionable laser sensor, for mounting the re-positionable laser sensor in selectable elevation on a manually relocatable rod, said assembly comprising:
a main body member;
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

42. In combination:
a main body member;
a track;
a sensor carrier operatively mounted on said track for movement along said track, wherein said sensor carrier comprises:
(1) a housing;
(2) a wheel mounted on said housing in rotatable relation about a main axis, wherein said wheel is operatively engaged on said track such that rotation of said wheel causes movement of said wheel along said track;
(3) means for selectively imparting rotation of said wheel about said main axis to thereby cause said sensor carrier to move along said track;
wherein, in use, when said handle is rotated, said wheel correspondingly rotates, thereby moving said wheel along said track, and correspondingly moving the sensor carrier along said track to a selected position.

43. An apparatus for use with a rotary laser level system having a rotary laser level that shines a laser light that is received by a remote re-positionable laser sensor, for mounting the re-positionable laser sensor in selectable elevation on a manually relocatable rod, said apparatus comprising:
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.

44. An apparatus according to claim 43, wherein said track is straight and said measurement strip is straight.

45. An apparatus according to claim 43, wherein said measurement strip is mounted in spaced relation from said track.

46. An apparatus according to claim 43, wherein said measurement strip has a first end and a second end and is mounted on said track by means of mounting brackets disposed one at each of said first end and said second end of said measurement strip.

47. An apparatus according to claim 43, wherein said electronic digital readout is mounted on said sensor carrier.

48. An apparatus according to claim 43, further comprising a pick-up housing disposed in surrounding relation around said measurement strip for movement therealong, and wherein said pick-up is mounted within said pick-up housing.

49. An apparatus according to claim 43, wherein said measurement strip comprises a magnetic strip having alternatively oriented magnetic sections.

50. An apparatus according to claim 43, wherein said strip sensor comprises a magnetic pick-up.

51. An apparatus according to claim 43, wherein said measurement strip is securely connected to said track.

52. An apparatus according to claim 43, wherein said measurement strip is securely connected to said track in parallel relation to said track.

53. An apparatus according to claim 43, wherein said track is mountable in fixed relation on said rod.

54. An apparatus according to claim 43, wherein said track is securely connected to said measurement strip.

55. An apparatus according to claim 43, wherein said track and said measurement strip are each mountable in fixed relation on said rod.

56. An apparatus according to claim 43, wherein said track and said measurement strip are integrally formed each with the other.

57. A kit comprising:
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.

58. An assembly for use with a rotary laser level system having a rotary laser level that shines a laser light that is received by a remote re-positionable laser sensor, for mounting the re-positionable laser sensor in selectable elevation on a manually relocatable rod, said assembly comprising:
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.

59. In combination:
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.

60. An apparatus for use with a rotary laser level system having a rotary laser level that shines a laser light that is received by a remote re-positionable laser sensor, for permitting selective re-positioning of the re-positionable laser sensor in selectable elevation, said apparatus comprising:
a main body member;
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.

61. An apparatus according to claim 60, wherein said track is straight and said measurement strip is straight.

62. An apparatus according to claim 60, wherein said measurement strip is mounted in spaced relation from said track.

63. An apparatus according to claim 60, wherein said measurement strip has a first end and a second end and is mounted on said track by means of a mounting bracket disposed at each of said first end and said second end of said measurement strip.

64. An apparatus according to claim 60, wherein said electronic digital readout is mounted on said sensor carrier.

65. An apparatus according to claim 60, further comprising a pick-up housing disposed in surrounding relation around said measurement strip for movement therealong, and wherein said pick-up is mounted within said pick-up housing.

66. An apparatus according to claim 60, wherein said measurement strip comprises a magnetic strip having alternatively oriented magnetic sections.

67. An apparatus according to claim 60, wherein said strip sensor comprises a magnetic pick-up.

68. An apparatus according to claim 60, wherein said measurement strip is securely connected to said track in parallel relation to said track.

69. An apparatus according to claim 60, wherein said track is mountable in fixed relation on said main body member.

70. An apparatus according to claim 60, wherein said measurement strip is securely connected to said track.

71. An apparatus according to claim 60, wherein said track is securely connected to said measurement strip.

72. An apparatus according to claim 60, wherein said track and said measurement strip are each mountable in fixed relation on said main body member.

73. An apparatus according to claim 60, wherein said track and said measurement strip are integrally formed each with the other.

74. An apparatus according to claim 60, wherein said track, said measurement strip and said main body member are integrally formed each with the other.

75. A kit comprising:
a main body member;
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.

76. An assembly for use with a rotary laser level system having a rotary laser level that shines a laser light that is received by a remote re-positionable laser sensor, for permitting selective re-positioning of the re-positionable laser sensor in selectable elevation, said apparatus comprising:
a main body member;
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.

77. In combination::
a main body member;
a track;
a sensor carrier operatively engageable with said track for travel along said track;
wherein said remote re-positionable laser sensor is mounted on said sensor carrier for travel with said sensor carrier along said track;
a measurement strip; and,
a strip sensor mounted on said sensor carrier for travel with said sensor carrier along said track and in adjacent relation to said measurement strip for movement along said measurement strip, for detecting changes in portions of said measurement strip as said strip sensor travels along said measurement strip;
wherein said strip sensor is connected in signal transfer relation to an electronic digital readout; and,
wherein, in use, when said sensor carrier is moved along said track, said strip sensor travels along said measurement strip and produces corresponding displacement signals and transmits said corresponding displacement signals to said electronic digital readout for use in displaying said elevation.
